(19) United States
(12) Patent Application Publication
(10) Pub. No.: US 2018/0217033 A1
(43) Pub. Date: Aug. 2, 2018

(54) Kit, Composition and Method for Preparing a Specimen for Imaging and Method for Diagnosing a Disease

(71) Applicant: The University of Manchester, Manchester (GB)

(72) Inventors: Stephen Yeates, Manchester (GB); Scott Lewis, Manchester (GB); Richard Winpenny, Manchester (GB)

(73) Assignee: The University of Manchester, Manchester (GB)

(21) Appl. No.: 15/748,353

(22) PCT Filed: Jul. 25, 2016
(86) PCT No.: PCT/GB2016/052273

§ 371 Date: Jan. 29, 2018

(30) Foreign Application Priority Data
Jul. 30, 2015 (GB) 1513460.4

(51) Int. Cl. G01N 1/30

(52) U.S. Cl. CPC G01N 1/30; G01N 2001/305

(57) ABSTRACT

The present invention relates to an imagable specimen sample, particularly an imagable histological sample for imaging via techniques such as scanning electron microscopy (SEM) and transmission electron microscopy (TEM). The invention provides imaging preparation compositions, such as resin compositions, which can be embedded within a specimen sample and can also encapsulate the sample. The compositions contain either or both of a secondary electron generator and/or a self-healing component. The secondary electron generator enhances image quality by increasing the amount of secondary electron scattering. The self-healing component minimises specimen sample damage caused by the imaging technique.

### INTRODUCTION

The present invention relates to an imagable specimen sample, particularly an imagable histological sample for imaging via techniques such as scanning electron microscopy (SEM) and transmission electron microscopy (TEM). The invention also relates to a method of preparing a specimen for imaging (i.e. preparing an imagable specimen sample), a method of imaging, an imaging preparation composition, a resin composition, a kit of parts, a method of preparing an imaging preparation composition and a resin composition, a post-imaged specimen, a method of re-imaging a post-imaged specimen, a use of a secondary electron generator, and a use of a self-healing component.

### BACKGROUND

Imaging of histological samples has become essential inter alia in diagnosing and prognosing a number of health conditions, and for a long time improvements in image quality and image information content has improved clinician's ability to effectively diagnose, prognose, and prescribe appropriate treatments.

Two main types of electron microscopy, Scanning Electron Microscopy (SEM) and Transmission Electron Microscopy (TEM), are routinely used in hospitals to analyse biopsy/histological samples. SEM and TEM use a beam of electrons (as primary incident radiation) to obtain an image of the sample. In SEM the initial beam of electrons (primary electrons) is passed through the sample. These primary electrons collide and interact with the sample molecules either elastically to produce back-scattered electrons, or inelastically to produce secondary electrons.¹ SEM generates an image by measuring either the secondary electrons or the back-scattered electrons produced in the scattering collisions. Secondary electron detection is the method most commonly used as back-scattered electron detection is expensive and not all SEM machines are equipped to measure them. Contrast agents in SEM, such as osmium tetraoxide (OsO₄) are used to enhance image contrast.²

In TEM, as an electron beam is passed through the sample the density of the sample itself affects the number of electrons that can pass through, and the image is collected on a photographic film or a CCD camera. Imaging agents that bind to specific parts of the sample are used so that localised imaging agents provide an increased local density to thereby reduce the number of electrons capable of passing therethrough. Ferritin, horseradish peroxidase and haemocyanin are examples of an imaging agents used in TEM.³

Problems associated with the use of SEM and TEM include difficult sample preparation and sample damage caused by the incident electron beam and scattered secondary electrons (as per proximity effects). Secondary electrons are produced when corresponding primary electrons lose energy through inelastic collisions until its energy reaches <50 eV. This energy loss causes beam damage to the sample through intrinsic sample heating and bond cleavage which alters the shape of the sample.⁴ In SEM a trade off exists between maximizing the number of secondary electrons generated to increase the signal intensity, improving the resolution, and beam damage of the sample. Where SEM is used, samples degrade with depth due to the increase in the number of secondary electrons generated with increasing sample thickness. However by lowering the voltage of the beam, the magnification and the time the sample is subjected to the electron beam can minimize this beam damage.²

SEM, although providing higher resolution images than optical microscopy, lags behind the superior resolution of images generating using TEM.^{2,3} However, the recent advent of the Gatan 3view2 SEM machine, which allows generation of three-dimensional images of cells^{3,5} marks a step forward and has led to an increasing preference for SEM over TEM imaging of histological samples. The Gatan 3view2 combines an ultramicrotome with a field emission gun scanning electron microscope (FEGSEM).

The ultramicrotome uses a diamond knife to cut a histological sample into thin sections, each of which can then be imaged to build a 3D picture of the sample. Previously it would have taken weeks to build up a 3D image of the sample using serial section imaging in TEM. However, with the new automated ultramicrotome technology these images can be collected in a few hours. The sample for the Gatan 3view2 must first be stained and then fixed in a polymer such as araldite or poly(methyl methacrylate) (PMMA) before being sliced into sections as thin as 15 nm so that images do not degrade with depth.⁵ With the Gatan 3view2, the ability to build up 3D images will improve the diagnostic ability of the pathology labs within hospitals. An added benefit of this new technology is that it can be retrofitted with imaging equipment already installed within hospitals.

Unfortunately, despite the significant advances made in the 3D imaging of histological samples, overall image quality/resolution remains sub-optimal, especially for SEM-based systems, and clinicians and patients would significantly benefit from an advance in image quality, contrast and resolution, since this would increase the effective information content off the images and allow for a higher degree of “zoom”. Moreover, sample preparation has not been perfected.¹ Furthermore, inspection of electron penetration depths (especially for low energy electrons) reveals that extensive chain scission occurs (i.e. damage to the resin within which the specimen is fixed). Such chain scission damages the inspection area and its surroundings. As such, when the diamond knife cuts a section after an initial section has been imaged/inspected with the electron beam, the underlying material will become damaged. It is then necessary for the diamond knife to remove the underlying area as well as the already-inspected section. Therefore, the area of interested is obliterated, making effective diagnosis impossible.

An object of the present invention is to address at least one of the problems inherent with the prior art.

Another object of the invention is to enable production of higher quality images.

Another object of the invention is to mitigate against sample damage caused during imaging.

### SUMMARY OF THE INVENTION

According to a first aspect of the present invention there is provided a method of preparing a specimen for imaging, the method comprising:
providing a specimen; and
transforming the specimen into an imagable specimen sample;
   wherein transforming the specimen into an imagable specimen sample comprises incorporating a secondary electron generator (or composition thereof) into the specimen.

According to a first aspect of the present invention there is provided a method of preparing a specimen for imaging, the method comprising:
providing a specimen; and
transforming the specimen into an imagable specimen sample;
   wherein transforming the specimen into an imagable specimen sample comprises incorporating a self-healing component (or composition thereof) into the specimen.

According to a further aspect of the present invention there is provided an imagable specimen sample, wherein the imagable specimen sample is obtained by, obtainable by, or directly obtained by a method of preparing a specimen for imaging as defined herein.

According to a further aspect of the present invention there is provided an imagable specimen sample, wherein the imagable specimen sample is a specimen incorporating a secondary electron generator and/or a self-healing component (or composition thereof) therein.

According to a further aspect of the present invention there is provided a method of imaging an imagable specimen sample, the method comprising:
imaging an imagable specimen sample as defined herein.

According to a further aspect of the present invention there is provided a method of imaging an imagable specimen sample, the method comprising:
preparing a specimen for imaging as defined herein; and
imaging the specimen for imaging.

According to a further aspect of the present invention, there is provided an image (whether a digital image stored on a computer-readable storage medium or a printed analog image) obtained by, obtainable by, or directly obtained by the method of imaging as defined herein.

According to a further aspect of the present invention, there is provided a method of diagnosing and/or prognosing a medical disease or condition, the method comprising examining an image as defined herein (suitably an wherein the original specimen is a histological specimen), and determining a diagnosis and/or prognosis on the basis of the examination of the image.

According to a further aspect of the invention, there is provided an imaging preparation composition, the composition comprising a secondary electron generator and/or a self-healing component.

According to a further aspect of the invention, there is provided a resin composition, wherein the resin composition comprises: a resin component; and an imaging preparation composition (i.e. comprises a secondary electron generator and/or a self-healing component).

According to a further aspect of the invention, there is provided a kit of parts comprising a resin component, a secondary electron generator, and/or a self-healing component.

According to a further aspect of the present invention, there is provided a method of preparing a resin composition, the method comprising mixing a secondary electron generator and/or a self-healing component with a resin component, optionally in the presence of a solvent or carrier.

According to a further aspect of the present invention, there is provided a post-imaged specimen, wherein the post-imaged specimen is obtained by, obtainable by, or directly obtained by the method of imaging as defined herein.

According to a further aspect of the present invention, there is provided a method of re-imaging a post-imaged specimen (i.e. that has already been the subject of imaging), wherein the method comprises: imaging the post-imaged specimen.

According to a further aspect of the present invention, there is provided a method of re-imaging a post-imaged specimen (i.e. that has already been the subject of imaging), wherein the method comprises: imaging an imagable specimen sample, as defined herein, to produce a post-imaged specimen; and thereafter imaging the post-imaged specimen.

According to a further aspect of the present invention, there is provided a use of a secondary electron generator during imaging of a specimen sample to increase image resolution of the resulting images, especially when digitally-magnified.

According to a further aspect of the present invention, there is provided a use of a self-healing component during imaging of a specimen sample to reduce damage to the specimen sample during imaging.

According to a further aspect of the present invention, there is provided a use of a self-healing component during imaging of a specimen sample to preserve imagability of the specimen sample following imaging.

Any features, including optional, suitable, and preferred features, described in relation to any particular aspect of the invention may also be features, including optional, suitable and preferred features, of any other aspect of the present invention.

### BRIEF DESCRIPTION OF THE DRAWINGS

For a better understanding of the invention, and to show how embodiments of the same are put into effect, reference is now made, by way of example, to the following diagrammatic drawings, in which:

FIG. 1 shows a graphical representation of scattering trajectories of the araldite system (750 nm) at am electron beam energy of 10 keV, number of electrons 10000;

FIG. 2 shows a graphical representation of scattering trajectories of the sodium tetrachloroaurate doped araldite system (750 nm) at a beam energy of 10 keV, number of electrons 10000.

FIG. 3 is a graph showing secondary electron production in the araldite system for different beam energies and sample thickness.

FIG. 4 is a graph showing secondary electron production in the araldite+sodium tetrachloroaurate system system for different beam energies and sample thickness.

FIG. 5 represents a combination of the data of FIGS. 3 and 4, and shows the ratio of secondary electron production of the sodium tetrachloroaurate doped araldite system to the araldite system.

FIG. 6 shows a SEM image of a rat kidney, stained with Osmium tetraoxide, in an araldite-only resin composition, with a thickness of 750 nm. At magnification; (a) mag ×1000, (b) mag ×5000, (c) mag ×10000, (d) mag ×15000, (e) mag ×20000 and (f) mag ×30000.

FIG. 7 shows images comparable to those of FIG. 6, except this time encapsulated in an araldite system doped with sodium tetrachloroaurate. The SEM image of a rat kidney was again stained with Osmium tetraoxide, cut to a thickness of 750 nm, and is shown at a magnification of (a) mag ×1000, (b) mag ×5000, (c) mag ×10000, (d) mag ×15000, (e) mag ×20000 and (f) mag ×30000, (g) mag ×45000, (h) mag ×50000, (i) mag ×65000.

FIG. 8 shows an SEM image of a rat kidney stained with Osmium tetraoxide, encapsulated in araldite, with a sample thickness of 750 nm (mag ×5000).

FIG. 9 shows an SEM image of a rat kidney stained with Osmium tetraoxide, encapsulated in araldite, with a sample thickness of 750 nm (mag ×10000).

FIG. 10 shows an SEM image of a rat kidney showing the beam damage. The rat kidney has been stained with Osmium tetraoxide, is encapsulated in araldite doped with NaAuCl₄, with a sample thickness of 750 nm (mag ×5000).

FIG. 11 shows an SEM image of a rat kidney showing that despite the beam damage an image is acquired with a brighter contrast. The rat kidney has been stained with Osmium tetraoxide, is encapsulated in araldite doped with NaAuCl₄, with a sample thickness of 750 nm (mag ×10000).

FIG. 12 shows a lithographic exposure pattern.

FIG. 13 shows an optical image of a typical section on a Silicon substrate that was exposed with a 5 KeV electron beam.

FIG. 14 shows a surface depth profile of the nanocomposite resin which was exposed with a 5 KeV electron beam.

FIG. 15 shows a surface depth profile of the nanocomposite resin which was exposed with a 10 KeV electron beam.

FIG. 16 shows a surface depth profile of the largest exposure dose.

FIG. 17 shows a depth profile of the nanocomposite resin which as 2.5% PET in it. This was exposed with a 5 KeV electron beam.

FIG. 18 shows a depth profile of the largest exposure dose. The sample is the nanocomposite resin which as 2.5% PET incorporated within it.

FIG. 19 shows a depth profile of the nanocomposite resin which incorporated PET and HgCl₂ molecules. These materials were exposed with a 5 KeV electron beam.

FIG. 20 shows a depth profile of the nanocomposite resin which incorporated PET and HgCl₂ molecules. These materials were exposed with a 10 KeV electron beam.

FIG. 21 shows a depth profile of the largest exposure dose, these materials had PET and HgCl₂ molecules incorporated into the resin.

### DETAILED DESCRIPTION OF THE INVENTION

### Definitions

Unless otherwise stated, the following terms used in the specification and claims have the following meanings set out below.

Herein, the term “imaging preparation composition” refers to a composition (suitably a liquid composition) that contains a secondary electron generator. The composition may, though not necessarily, be a resin composition as defined herein, especially where hardening/setting of an image is required prior to any imaging.

Herein, the term “resin” or “resin composition” refers to any component or composition which is transformable from a fluid or liquid state into a hardened state (preferably into a substantially solid state or into an extremely viscous and non-flowing liquid), suitably in a substantially irreversible manner. Suitably a resin can be “set” under appropriate conditions (e.g. elevated temperature). Suitably a resin comprises an organic compound, suitably an organic polymer, which is primarily responsible for the setting/hardening of the resin. Classical plant resins may also be used, but synthetic resins are preferred. For instance, resins (or resin compositions) suitably includes compositions such as araldite and other such “casting resins” that can be set, suitably either thermally (as per araldite) and/or chemically (such as epoxy resin). The resin composition may comprise monomeric compounds which, upon setting/hardening, polymerise to form polymers, suitably thermosetting polymers or plastics.

Herein, a “secondary electron generator” is a component which releases secondary electrons following irradiation, suitably with ionizing radiation. In a particular embodiment, the secondary electron generator releases electrons when exposed to an electron beam.

“Self-healing materials” are well known and are often used as a means of self-repairing materials which incur mechanical damaged during use. Often such repair is substantially spontaneous and does not require any human intervention. Self-healing can involve processes similar to wound-repair in biological systems. For example, a damage-response cascade may involve an initial trigger event (suitably immediately after damage occurs), which (if required) causes transport of relevant healing materials (e.g. a self-healing component as defined herein) to the damaged site, before the damaged site is finally chemically repaired by the healing materials. The exact self-repair process suitably depends on the ultimate chemical healing method, which can include methods such as polymerization, entanglement, and (optionally-reversible) cross-linking. In the context of the invention, self-repairing materials may be employed to preserve the structural integrity of an imagable specimen sample so as to reduce damage caused to the imagable specimen sample during imaging.

Herein, a “self-healing component” is healing material. A self-healing component is suitably a component (e.g. of a compound, composition, or material) capable of chemically-reacting with (“damaged”) species or intermediates of an imagable specimen sample generated during imaging of the imagable specimen sample in a manner which preserves the physical structural integrity (i.e. solidity) of the imagable specimen sample (especially the imaged surface thereof and bulk underlying said surface), though naturally the imagable specimen sample will be chemically transformed (e.g. where damage is characterized by a bond breakage between two atoms or groups, the repair process may link each of the two atoms or groups to different atoms or groups, optionally via the self-healing component where the self-healing component becomes a cross-linker). Suitably an imagable specimen sample may comprise a self-healing component which essentially renders the imagable specimen sample as self-healing material. Suitably a resin composition of the invention may comprise a self-healing component, either as a distinct component of the composition (e.g. a sacrificial cross-linker) or as part of a resin polymer itself (e.g. by virtue of certain pendent groups of the polymer which may respond to damage by reacting intra- or inter-molecularly). Suitably a self-healing component reacts with one or more homolytic (e.g. radical) and/or heterolytic (e.g. ionic) by-products of a bond breakage to re-bond (suitably covalently) said one or more homolytic and/or heterolytic by-products to another atom or group. Various means of restraining the damage response, until actual damage occurs, are known in the art. For instance, “self-healing components” may be capsule based, vascular, or intrinsic, all of which differ slightly in the manner of their damage-response. For example, capsule based self-healing components may be provided in capsules that release the self-healing component only when ruptured, thereby restraining any damage response until damage is caused (especially where capsule rupture is caused by the same factor(s) causing the damage itself).

Herein, the “effective atomic number (Z_{eff})” of a compound is the average atomic number obtained from a weighted summation of the atomic constituents of a compound.

Though the skilled person will be aware of a variety of ways to calculate and/or measure Z_{eff} (e.g. F. W. Spiers, Effective Atomic Number and Energy Absorption in Tissues, Br. J. radiol., 19, 52, 1946), for the purpose of the present invention “effective atomic number (Z_{eff})” is suitably calculated as a simple mass-weighted average, suitably using the formula:

Z_{eff}=ΣαᵢZᵢ

Where Zᵢ is the atomic number of the ith element in the compound, and αᵢ is the fraction of the sum total of the atomic numbers of all atoms in the compound (i.e. the total number of protons in the compound) constituted by said ith element. This formula may otherwise be expressed as:

Z_{eff}=α₁Z₁+α₂Z₂+ . . . (+αₙZₙ)

for a compound comprising n elements.
This is similar to the Spiers equation (F. W. Spiers, Effective Atomic Number and Energy Absorption in Tissues, Br. J. radiol., 19, 52, 1946) but without the exponents used by Spiers. The Spiers equation states Z_{eff} as follows:

Z_{eff}^{p}=ΣαᵢZᵢ^{p}

where the exponent p is suitably approximately 3 (e.g. p=2.94). Though in certain embodiments, this Spiers definition (especially with p=2.94) of Z_{eff} may be used, and any preferred, optional, and suitable values of Z_{eff} disclosed herein may equally apply to the Spiers definition, preferably the abovementioned simple mass-weighted average definition of Z_{eff} should be used.
The secondary electron generator may suitably be or comprise a compound having an effective atomic number (Z_{eff}) greater than or equal to 15 (optionally when the effective atomic number calculation excludes any solvates having a boiling point less than or equal to 150° C. at 100 kPa pressure) By way of example, though the metal compound/complex HAuCl₄.4H₂O (hydrogen tetrachloroauratetetrahydrate) has an effective atomic number (Z_{eff}) of 40.76 when the solvate (4×H₂O) is included in the calculation, HAuCl₄.4H₂O has an effective atomic number (Z_{eff}) of 49.99 when water (which has a boiling point less than 150° C.) is excluded from the calculation, because:
firstly, the 4H₂O part of the compound is excluded from the calculation because water is a solvate (or hydrate) having a boiling point of less than or equal to 150° at 100 kPa pressure (its boiling point is 150° at 100 kPa pressure);
The relevant atomic numbers of HAuCl₄.4H₂O are therefore:
   Z_{H}=1
   Z_{Au}=79
   Z_{Cl}=17
The sum total of all atomic numbers in HAuCl₄.4H₂O, excluding 4H₂O (i.e. HAuCl₄), is:

Z_{H}+Z_{Au}+(4×Z_{Cl})=1+79+(4×17)=148
The relevant atomic number fractions for HAuCl₄.4H₂O are:
   α_{H}=1/148=0.00676
   α_{Au}=79/148=0.53378
   α_{Cl}=(4×17)/148=0.45946
The Z_{eff} calculated using the equation Z_{eff}=α_{H}Z_{H}+α_{Au}Z_{Au}+α_{Cl}Z_{Cl} is:

Z_{eff}=(0.00676×1)+(0.53378×79)+(0.45946×17)

Z_{eff}=0.00676+42.168+7.81082=49.99

The effective atomic number of organic compounds can be calculated in exactly the same fashion—typically there will be no need to discount solvate molecules in such cases, since solvates are more commonly associated with metal complexes. The effective atomic number of polymers may also be calculated in the same manner, though it is simplest to perform such calculations upon the monomer only, since this yields the same result. As such, the Z_{eff} of PMMA (or methylmethacrylate) is approximately ˜5.85. The effective atomic number of co-polymers may again be calculated in the same manner, though this time weighted averages of the respective monomers should be built into the equation. Likewise, though not generally relevant to the present invention, the effective atomic number of compound mixtures or compositions may also be calculated by including weighted averages of the respective components thereof. The skilled person is perfectly capable of calculating the effective atomic number (Z_{eff}) for all compounds and compositions.

Herein, a “base component” in the context of a resin composition is a component which accompanies the secondary electron generator. Such a “base component” may act as a vehicle for the secondary electron generator and/or serve another function, such as undergoing a change (e.g. of visibility during imaging) upon exposure to radiation. The base component is suitably a polymeric component.

Herein, any parameters given in relation to compound(s) (e.g. Z_{eff}, density, mean free path, scattering cross-sectioning, mean ionization potential/stopping power, electron emission yield) suitably relate to the (substantially) pure or isolated form of said compound(s) and not to said compound(s) when in admixture with other components (i.e. in a composition). The following Tables illustrate exemplified values for such parameters in relation to specific compounds:

| | Molecular Weight | Effective Atomic | Density |
|---|---|---|---|
| Material | (g/mol) | Number | (g/cm³) |
| PMMA | 10.1 (*) 100.12 | 5.85 | 1.19 |
| AlCl3 | 133.34 | 16.14 | 2.48 |
| ScCl3 | 151.31 | 18.16 | 2.39 |
| YCl3 | 195.26 | 26.53 | 2.67 |
| LaCl3 | 371.37 | 38.11 | 3.84 |
| HAuCl4•4H2O | 409 | 40.76 | 2.89 |
| HAuCl4 | 339.785 | 49.99 | 3.9 |
| ErCl3 | 381.71 | 46.07 | 4.1 |
| AuCl3 | 303.325 | 55 | 4.7 |

(*) the molecular weight given for PMMA is that of the monomer repeat unit, since this is what is considered in the Monte Carlo simulation since it is the unit cell that is relevant given that it is repeated over the volume of the material space within the model, in this case 800 × 800 × 100 nm.

The following table shows all of the values for the elastic and inelastic scattering cross sections and also their associated mean free paths. All values are determined from equations 2, 3, 4 and 7 outlined herein.

| | Elastic | Inelastic | Elastic | Inelastic |
|---|---|---|---|---|
| | scattering | scattering | Mean | Mean |
| | cross section | cross section | Free Path | Free Path |
| Material | (cm/atom) | (cm/atom) | (Å) | (Å) |
| PMMA | 1.77E−18 | 1.25E−10 | 7986 | 33297 |
| AlCl3 | 6.86E−18 | 5.98E−11 | 1306 | 7617 |
| ScCl3 | 8.01E−18 | 6.04E−11 | 1317 | 7983 |
| YCl3 | 1.32E−17 | 5.35E−11 | 923 | 6333 |
| LaCl3 | 2.14E−17 | 4.67E−11 | 498 | 3847 |
| HAuCl4•4H2O | 2.34E−17 | 7.34E−11 | 1015 | 8025 |
| HAuCl4 | 3.07E−17 | 4.94E−11 | 473 | 4000 |
| ErCl3 | 2.76E−19 | 4.31E−11 | 403 | 3319 |
| AuCl3 | 3.46E−19 | 4.03E−11 | 311 | 7617 |

Unless stated otherwise, any reference herein to an “average” value is intended to relate to the mean value.

Herein, unless stated otherwise, the term “parts by weight” (pbw) when used in relation to multiple ingredients/components, refers to relative ratios between said multiple ingredients/components. Though in many embodiments the amounts of individual components within a composition may be given as a “wt %” value, in alternative embodiments any or all such wt % values may be converted to parts by weight to define a multi-component composition. This is so because the relative ratios between components is often more important than the absolute concentrations thereof. Where a composition comprising multiple ingredients is described in terms of parts by weight alone (i.e. to indicate only relative ratios of ingredients), it is not necessary to stipulate the absolute amounts or concentrations of said ingredients (whether in toto or individually) because the advantages of the invention stem from the relative ratios of the respective ingredients rather than their absolute quantities or concentrations. However, suitably, the resin composition comprises at least 1 wt % of all the stipulated ingredients combined (excluding any diluents/solvents), suitably at least 5 wt %, suitably at least 10 wt %, suitably at least 15 wt %. Suitably the resin composition comprises at most 50 wt % of all the stipulated ingredients combined (excluding any diluents/solvents), suitably at most 30 wt %, suitably at most 20 wt % thereof. The balance (i.e. the remainder of the resin composition not constituted by the stipulated ingredients, excluding diluents/solvents) may consist essentially of a diluent(s)/solvent(s).

Herein, unless stated otherwise, the weight percentage (wt %) of any given component within a composition suitably means the percentage by weight of said component based on the overall weight of the composition.

Where the quantity or concentration of a particular component of a given composition is specified as a weight percentage (wt % or % w/w), said weight percentage refers to the percentage of said component by weight relative to the total weight of the composition as a whole. It will be understood by those skilled in the art that the sum of weight percentages of all components of a composition will total 100 wt %. However, where not all components are listed (e.g. where compositions are said to “comprise” one or more particular components), the weight percentage balance may optionally be made up to 100 wt % by unspecified ingredients (e.g. a diluent, such as water, or other non-essentially but suitable additives).

Herein, where a composition is said to “consists essentially of” a particular component, said composition suitably comprises at least 70 wt % of said component, suitably at least 90 wt % thereof, suitably at least 95 wt % thereof, most suitably at least 99 wt % thereof. Suitably, a composition said to “consist essentially of” a particular component consists of said component save for one or more trace impurities.

Suitably, unless stated otherwise, where reference is made to a parameter (e.g. pH, pKa, etc.) or state of a material (e.g. liquid, gas, etc.) which may depend on pressure and/or temperature, suitably in the absence of further clarification such a reference refers to said parameter at standard ambient temperature and pressure (SATP). SATP is a temperature of 298.15 K (25° C., 77° F.) and an absolute pressure of 100 kPa (14.504 psi, 0.987 atm).

Herein, unless stated otherwise, references to any standard electrode potential values are given in volts relative to a standard hydrogen electrode at 298.15 K (25° C.); an effective concentration of 1 mol/L for each species or a species; a partial pressure of 101.325 kPa (absolute) (1 atm, 1.01325 bar) for each gaseous reagent.

### General Points and Advantages of the Invention

The present invention provides inter alia materials (e.g. resin compositions) and techniques for preparing specimen samples (e.g. biopsies) for imaging, in particular SEM imaging.

The techniques of the invention generally involve incorporating powerful secondary electron generators, as defined herein, into the “fabric” of a specimen sample (e.g. embedded at the surface and/or into the bulk of the specimen sample, for example into any available pores) to artificially amplify, and thereby enhance the detectability of, inelastically-scattered secondary electrons which are, as a matter of course, produced following exposure of the specimen sample to certain types of radiation (e.g. incident primary electrons from an electron beam, such as those used in SEM or TEM imaging).

Though detection of inelastically-scattered secondary electrons is known, for various reasons it has always been a priority to minimise secondary electron production during imaging. For instance, inelastically-scattered secondary electrons tend to damage nearby material (which may also need to be accurately imaged) around that from which they were initially produced/scattered—this is a result of well-known “proximity effects” associated with secondary electrons, which have always been seen as deleterious effects. In the context of SEM imaging, such proximity effects can for instance cause significant damage within the bulk material underlying the imaged surface, meaning that any sectioning (to produce 3D images of a specimen) must take account of such damage by cutting away a sufficiently thick section before continuing to image any fresh underlying surface. As such, conventional wisdom when imaging biological tissue samples generally dictates that secondary electron scattering should be minimised and, instead of pre-amplifying secondary electron scattering (as per the invention), any detection signals derived from inelastically-scattered secondary electrons should be post-amplified.

The present invention, somewhat counterintuitively, utilises and harnesses the power and potential of these secondary electron signals to produce better secondary-electron-based images with much greater magnification potential (i.e. owing to better signal-to-noise ratios at high magnifications). The invention can also improve the detection and resolution of images based on backscattered electrons.

The present invention also offers a way to contain/reduce collateral damage caused by incident radiation and/or secondary electrons through the judicious use of a self-healing component. When incorporated within an imagable specimen sample (e.g. using an imaging preparation composition or resin composition), self-healing components can immediately repair structurally-damaged parts of the imagable specimen sample by essentially tying up “loose ends” (formed as a result of bond breakages), whether the “loose ends” are tied together or tied to an auxiliary anchor.

The inventors have additionally identified and modeled key parameters (e.g. Z_{eff}) and algorithms to enable the skilled person to reap the benefits of the present invention through utilizing a wide range of secondary electron generators or selecting from a wide range of secondary electron generators depending on other important factors.

The present invention, in conjunction with this specification, equips the skilled person with the tools to obtain high quality, highly detailed images of various specimen types (especially biological specimens) using standard existing equipment optionally alongside existing sample-preparation/fixing resins and procedures. In particular embodiments, where the specimen is a biological tissue sample (e.g. a biopsy), the present invention will assist health organisations offer improved diagnostic capabilities and health outcomes at significantly reduced cost.

### Preparation of Specimen for Imaging

The present invention provides a method of preparing a specimen for imaging.

The method of preparation suitably produces an imagable specimen sample.

The method suitably comprises one or more specimen processing steps to produce the imagable specimen sample. The one or more specimen processing steps may depend, at least in part, in one or more factors, which may suitably include factors such as: the nature, size, porosity, and/or density of the specimen; the nature of the imaging for which the specimen is being prepared (e.g. radiation type); the extent and/or depth of the imaging; the specification and/or any limitations associated with any apparatus employed during imaging; and/or any established specimen preparation protocols.

Suitably the method of preparing a specimen for imaging comprises providing a specimen and transforming the specimen into an imagable specimen sample, suitably by incorporating a secondary electron generator (suitably as defined herein) or a composition thereof (e.g. imaging preparation composition or resin composition) into the specimen (and/or a surface thereof). Herein, “incorporating [a material] into the specimen” suitably includes where the material is both integrated within the bulk of the specimen as well as embedded within (or coating upon) a surface thereof. However, in certain embodiments such “incorporating” includes including said material in the bulk of the specimen at least. Suitably the secondary electron generator is absorbed and/or adsorbed (collectively “sorbed”) within the specimen sample (though secondary electron generator may be present at the surface also).

### Providing a Specimen

The method suitably comprises providing the specimen. Providing the specimen suitably excludes any steps involving treatment(s) of a human or animal body, surgery or therapy or diagnostic methods practised on a human or animal body. Though the specimen could be any suitable article or substrate, particular those with facets of interest (whether 2-dimensional or 3-dimensional surface facets, bulk facets, and/or non-surface internal facets) on a nanoscopic and/or microscopic scale (i.e. which are invisible to the “naked eye”), most suitably the specimen is an article or substrate comprising a non-homogenous physical structure (at least on a nanoscopic and/or microscopic scale) throughout its bulk, suitably with 3-dimensional facets of interest. In a particular embodiment, the specimen is a biological sample, suitably a biological tissue sample, suitably a histological sample (or biopsy), for instance, such as a biological tissue sample originally obtained by an incisional biopsy. Suitably, the specimen is a substrate prone to degradation over time, and suitably requires one or more preservation treatments to preserve the imagable structure of the specimen (e.g. histological architecture of tissue cells).

Transforming Specimen into an Imagable Specimen Sample

Suitably, transforming the specimen into an imagable specimen sample is at least one of the one or more specimen processing steps to produce the imagable specimen sample, and suitably involves incorporating a secondary electron generator (suitably as defined herein) or a composition thereof (e.g. imaging preparation composition or resin composition) into the specimen (and/or a surface thereof). Alternatively or additionally such transforming may involve incorporating a self-healing component (suitably as defined herein) or a composition thereof (e.g. imaging preparation composition or resin composition) into the specimen (and/or a surface thereof).

Incorporating the secondary electron generator and/or self-healing component may suitably comprise contacting the specimen with a secondary electron generator and/or self-healing component, suitably a composition thereof, most suitably a liquid composition comprising a secondary electron generator and/or self-healing component. Suitably such contacting is sustained for a time sufficient to allow incorporation of the secondary electron generator and/or self-healing component within the specimen. Suitably such incorporation involves sorbing the secondary electron generator and/or self-healing component (or composition thereof—preferably an imaging preparation composition, which composition is most suitably a resin composition as defined herein) within the specimen, suitably via absorption and/or adsorption, whether via physisorption, chemisorptions, or both. Most suitably incorporation of the secondary electron generator and/or self-healing component involves a resin infusion treatment as described herein.

The secondary electron generator, once sorbed within the specimen, suitably amplifies any secondary electron scattering that may occur during imaging.

The self-healing component, once sorbed within the specimen, suitably promotes self-healing of an imagable specimen sample during imaging of said imagable specimen sample.

In addition to incorporating the secondary electron generator and/or a self-healing component, one or more other treatments may be employed to prepare the specimen for imaging.

### Preservation/Fixation

The one or more specimen processing steps may suitably comprise preserving the specimen, for example, by one or more physical and/or chemical preservation treatments. Preservation of the specimen is potentially important to ensure that any subsequently-obtained image of the corresponding imagable specimen sample is a suitably accurate representation of the specimen at the time of its provision. Such preservation treatments suitably quench, inhibit, or otherwise retard any physical, chemical, and/or biological processes which may, over time, cause undesirable degradation of or changes in the specimen. Such degradation may otherwise lead to images which fail to provide an accurate representation of the specimen at the time of its provision, which could in turn cause mistakes in subsequent analysis.

Physical preservation treatments may include exposing (or storing) the specimen to (at) reduced temperatures (e.g. a temperature ≤15° C., suitably ≤5° C., suitably ≤0° C.) for a suitable period of time.

Chemical preservation treatments may suitably involve contacting (e.g. by immersion) the specimen with one or more compounds or compositions (e.g. one or more preserving agents). Any, some or all physical and/or chemical treatments may be performed sequentially and/or simultaneously. Suitably a chemical preservation treatment comprises infusing the specimen with the one or more preserving agents.

Where the specimen in question is or comprises a biological sample, for example, a histological sample, preservation may be particularly important in order to preserve the histological architecture of any relevant cells and/or multicellular structures. In such cases, preserving the specimen may suitably involve “fixing” the specimen. As those skilled in the art will readily appreciate, such fixing of the specimen suitably involves one or more fixation treatments, including any number of those known in the art. The skilled person can employ routine workshop practice to determine an appropriate fixation treatment(s) based, for instance, on the nature of the specimen itself and/or the desired output of any imaging and analysis thereof. The fixation treatment(s) may suitably involve: freezing (e.g. chilling or freezing the specimen to arrest or retard specimen degradation—freezing can sometimes compromise morphological details, especially where cryogenic freezing is used); heat fixation (e.g. heat-killing the tissue and any associated organisms—this can be undesirable where damage is caused to internal structures and/or overall morphology, but morphology is often preserved during heat fixation), immersion (e.g. in a “fixative” which suitably diffuses through the specimen).

Most suitably, fixation of the specimen involves one or more chemical fixation treatments, suitably with one or more fixatives (i.e. fixing agents or fixing compositions). Such chemical fixation treatment(s) suitably (chemically and structurally) preserve the specimen in a state which closely resembles that of living tissue. Suitably, chemical fixative(s) stabilise proteins, nucleic acids, mucosubstances, and the like within the specimen to thereby render them substantially insoluble, especially substantially aqueous insoluble (especially under conditions prevailing within the specimen, e.g. at a given pH). Suitable chemical fixatives may include crosslinking fixatives (e.g. aldehydes, for instance, formaldehyde, glutaraldehyde, which generally preserve secondary and often tertiary protein structures); precipitating fixatives (e.g. with methanol, ethanol, and/or acetone, which preserves nucleic acids but denatures proteins); oxidising fixatives (e.g. OsO₄, HgCl₂, chromates, dichromates, permanganates, Zenker's mercurial fixative, which generally preserve fine cell structure, often at the expense of significant denaturing); picarates; and/or HOPE fixative (preserves proteins and nucleic acids well without cross-linking).

### Staining

The one or more specimen processing steps may suitably comprise staining the specimen. Staining the specimen suitably improves image quality in any subsequent imaging of the imagable specimen sample. As such, staining the specimen may involve staining the specimen with one or more staining agents (or staining compositions), suitably by contacting the specimen with a staining agent, such as a contrast agent. Suitably staining the specimen comprises infusing the specimen with the one or more staining agents.

Any suitable staining method may be employed, include any of those known in the art of histological staining (a process which typically follows fixation, though there can be overlap in the agents used).

Suitably, staining comprises embedding and/or impregnating one or more staining agents within the specimen (e.g. within the pores and/or bulk structure thereof). Where the specimen is a biological specimen, suitably staining comprises impregnating cell membranes with one or more staining agents.

In some embodiments, particularly where specimens are being prepared for SEM imaging, the process of staining and/or application of staining agents may replace the need for any splutter coating (see below).

Suitably, the one or more staining agents are reactive compounds, suitably reactive compounds which chemically react with(in) the specimen (or part(s) thereof) to deliver enhanced image contrast for the given imaging technique.

Suitably, the one or more staining agents are oxidising compounds (i.e. oxidising agents), suitably oxidising compounds which become reduced (suitably to a substantially insoluble compound or element) with(in) the specimen. Suitably the staining agent(s) have a standard electrode potential greater than or equal to +0.7V, suitably greater than or equal to +0.85V, suitably greater than or equal to +0.9V.

Suitably, the one or more staining agents are selected from metal compounds, suitably metal compounds which chemically react with the specimen (or part(s) thereof) to deliver enhanced image contrast for the given imaging technique. Suitably the relevant metal compound(s) are oxidising agent(s), which become reduced within the specimen when the specimen is stained therewith.

Suitably, the one or more staining agents are selected from metal compounds, for instance, including compounds of osmium, uranium, lead, ruthenium, tungston, molybdenum, cadmium, iron, indium, lanthanum, silver, gold, thallium, vanadium, and/or a mixture of any, some or all thereof.

Suitably, the one or more staining agents may be selected from the group consisting of: osmium tetroxide, uranyl acetate, ruthenium tetroxide, phosphotungstic acid, ammonium molybdate, cadmium iodide, carbohydrazide, ferric chloride, hexamine, indium trichloride, lanthanum nitrate, lead acetate, lead asparate, lead citrate, lead(II) nitrate, periodic acid, phosphomolybdic acid, potassium ferricyanide, potassium ferrocyanide, ruthenium red, silver nitrate, silver proteinate, sodium chloroaurate, thallium nitrate, thiosemicarbazide, uranyl nitrate, and vanadyl sulfate.

Suitably, the one or more staining agents comprise at least one contrast agent.

### Resin Infusion Treatment

The one or more specimen processing steps suitably comprise one or more resin treatment steps, wherein the or each resin treatment suitably comprises contacting the specimen (suitably a specimen that has been previously fixed and/or stained) with a resin composition (or imaging preparation composition). Suitably the or at least one of the resin treatment(s) is a resin infusion treatment. Suitably the resin infusion treatment comprises infusing the specimen with a resin composition and/or eluting the specimen with a resin composition.

Infusing the specimen with a resin composition suitably involves contacting the specimen with the resin composition for a time sufficient for at least some (suitably substantially complete) infusion of the specimen to occur. During contacting of the specimen, a number of additional techniques known in the art may be employed to facilitate infusion (or soaking) and/or increase the rate of infusion. For instance, during contacting, the specimen may be subjected to agitation, for example centrifugation.

Suitably any such resin treatments are performed at a temperature and/or for a period of time that maintains the resin composition(s) in fluid state (e.g. liquid). Suitably such resin treatments are performed at a temperature between −10 and 50° C., more suitably at a temperature between 0 and 40° C., more suitably at a temperature between 15 and 30° C.

Suitably, the specimen is washed with a suitably washing composition (e.g. water, acetone, buffered solution) prior to a first resin treatment.

After each resin treatment, the specimen is suitably separated from a used resin composition (e.g. an immersed or contacted specimen is separated from any reservoir of resin composition) (notwithstanding any resin composition infused within the specimen, which may suitably remain infused therein), optionally washed (e.g. with a washing composition—e.g. water or buffered water), and optionally thereafter subjected to a further resin treatment (suitably using a fresh resin composition). Suitably the process involves two or more resin treatments, suitably using substantially the same resin composition or a resin composition comprising substantially the same relative amounts (by weight) of ingredients but at a different overall concentration. Suitably earlier resin treatments employ a resin composition (in terms of absolute ingredient concentrations) that is relatively more dilute than a, some, or all subsequent resin treatments.

Suitably the specimen is substantially infused with the/a resin composition following the resin treatment(s).

The resin composition used in the foregoing resin treatments is suitably a resin composition as defined herein. Suitably the resin composition is a fluid (suitable substantially liquid or free-flowing solution, liquid dispersion, and/or liquid suspension) that hardens (suitably to form a solid block) when exposed to appropriate hardening conditions (e.g. elevated temperature/curing/baking). Infusing the specimen with resin composition suitably allows the specimen itself to be “hardened” (and thus physically stabilised) along with the resin composition when a resin-infused specimen is subjected to appropriate hardening conditions. The resin-infused specimen may be hardened and used in an unencapsulated form—under such circumstances, hardening/setting may be performed in any suitable manner, including those described in relation to the hardening/setting of a resin-encapsulated specimen, and this step may yield an imagable specimen sample for use in imaging. However, for improved machine handling the resin-infused specimen is suitably encapsulated within a resin block. The resin block may suitably comprise or be substantially made of the same (at least in terms of relative concentrations of ingredients other than solvent(s)) as the resin composition(s) infused within the specimen. However, as the skilled person will readily appreciate, the benefits of the invention may still be realised so long as the specimen is infused with a resin composition of the invention, even if the block resin within which the specimen is ultimately encapsulated is formed from a different resin composition.

### Resin Block Encapsulation

The one or more specimen processing steps suitably comprise a resin block encapsulation step, suitably comprising encapsulating (or embedding of) the specimen (suitably a resin-infused specimen, optionally with the same resin) within a resin block. Such encapsulation, which suitably increases the overall “hard” volume of the specimen sample, suitably facilitates machine handling of the sample.

Suitably encapsulating the specimen comprises contacting the specimen (suitably resin-infused specimen) with a resin composition, suitably a resin composition of the invention (though the resin composition may be different, so long as it fulfills the required properties of a resin). Suitably such contacting involves immersing (suitably completely immersing or submerging) the specimen within a reservoir of the relevant resin composition. Suitably the specimen-immersed resin composition is subjected to setting/hardening conditions (suitably within an appropriate container, especially a container that may be separated from any post-hardened resin block), suitably for sufficient time to cause the resin composition to harden to a specimen-encapsulated resin block.

Those skilled in the art (especially those skilled in the art of histology) are able to determine appropriate conditions and the required hardness. Suitably any setting/hardening conditions harden both the resin composition infused within the specimen and the resin composition of the resin block within which the specimen is encapsulated.

Suitably, subjecting the specimen-immersed resin composition to hardening conditions comprises exposing said specimen-immersed resin composition to elevated temperature, suitably a temperature of at least 30° C., more suitably at least 45° C., suitably at least 55° C., suitably about 60° C., though suitably the temperature is at most 200° C., suitably at most 150° C., suitably at most 100° C., suitably at most 70° C. Suitably the exposure to elevated temperature(s) is sustained for a sufficient time for the required hardening/setting to occur, suitably at least 1 hour, suitably at least 2 hours, suitably at least 12 hours, suitably at least 24 hours, suitably at least 48 hours, suitably about 48 hours.

Suitably the specimen-encapsulated resin block is separated from any container within which the specimen-encapsulated resin block is held (the container having served its function as a pseudo-mould may be disposed of). The specimen-encapsulated resin block is then suitably ready for imaging or any pre-imaging treatments. As such, the specimen-encapsulated resin block may constitute an imagable specimen sample.

### Processing of Hardened/Set Specimen-Encapsulated Resin Block or Resin-Infused Specimen

A resin-treated specimen, be it a specimen-encapsulated resin block or a hardened/set resin-infused specimen (i.e. unencapsulated but hardened), may undergo one or more further specimen processing steps prior to imaging. Such further specimen processing steps may be implemented using automated machinery, such as an ultramicrotome (well known in the art for processing an imaging a histological sample).

Any, some, or all of the following steps may suitably provide an imagable specimen sample.

### Mounting

Where a, some, or all further processing steps are implemented using automated machinery, the further processing steps suitably comprise mounting the resin-treated specimen, most suitably a specimen-encapsulated resin block (which is prepared to facilitate machine handling of the specimen sample), to or within said automated machinery. Such mounting may suitably involve mounting the resin-treated specimen on one or more specimen pins or specimen holders, for instance, using an appropriate adhesive (e.g. cyanoacrylate glue).

### Precision Cutting

The further processing steps may suitably comprise shaping the resin-treated specimen (e.g. specimen-encapsulated resin block), suitably by cutting and/or trimming the resin-treated specimen. Suitably such cutting is performed using a cutting device, for instance, a knife (e.g. glass or diamond knife). Suitably such cutting involves cutting the resin-treated specimen so as to provide a substantially flat imagable face (i.e. which can be ultimately faced, sectioned, and imaged). Suitably, in this context, a substantially flat surface is a surface with a “root mean square surface roughness” less than or equal to 30 nm, suitably less than or equal to 20 nm, suitably less than or equal to 10 nm, suitably less than or equal to 5 nm, where “root mean square surface roughness” is a term of art that may be expressed as:

$${R}_{q} = √ \frac{1}{n} {\sum }_{i = 1}^{n} {y}_{i}^{2}$$

where R_{q} is the root mean square roughness determined by reference to n ordered, equally spaced points along a 2D trace representing part of the surface, and yᵢ is the vertical distance from a hypothetical mean line (of all points) to the ith data point, where the height is +ve in the up direction, away from the bulk material.

Cutting may optionally be performed to leave the underlying specimen non-exposed at the imagable face (e.g. the specimen remains covered by a layer of hardened resin composition—this helps to avoid contamination in subsequent processes such as grounding). Suitably, such cutting involves cutting the resin-treated specimen so as to expose at least one surface of the specimen itself.

In a particular embodiment, the resin-treated specimen is cut to provide a wafer (suitably of substantially uniform thickness [e.g. +/−10% peak-to-trough, more suitably +/−2%, more suitably +/−1%, more suitably +/−0.01%], suitably with an average thickness less than or equal to 1 mm, suitably less than or equal to 100 μm, suitably less than or equal to 1 μm, suitably less than or equal to 100 nm) of resin-treated specimen, suitably having a surface area between 0.01 mm² to 10 mm², most suitably 1.0 mm² (i.e. 1.0 mm×1.0 mm). Suitably the wafer is a square wafer, and suitably the side-faces (i.e. the thickness) of the wafer comprise exposed specimen.

### Grounding

The further processing steps may suitably comprise electrically grounding any exposed specimen, for instance at the side faces of the aforementioned wafer. Such electrical ground may be performed by applying a grounding composition (which is suitably an electrically conductive composition, such as silver paint) to exposed portions of the specimen. The applied grounding composition is then suitably connected to a component (e.g. a part of the automated machinery) which is electrically grounded/earthed (e.g. the mounting pin of the automated machinery). Suitably the grounding composition is carefully applied to avoid contaminating the imagable surface or a part of the resin-treated specimen that will ultimately be sectioned and/or imaged (since this may affect the quality of the imaging process).

### Sputter Coating

The further processing steps may suitably comprise sputter coating some or all of the resin-treated specimen (e.g. the wafer). Such sputter coating suitably involves coating the surface(s) of the resin-treated specimen with a sputtering coating composition. Sputtering coating compositions are well known in the art and may, for example, include elemental metals such as gold and palladium, or a mixture thereof.

### Surfacing

The further processing steps may suitably comprise “surfacing” of the resin-treated specimen (e.g. the wafer). Such surfacing suitably involves cutting away a top layer of the resin-treated specimen to expose fresh specimen (albeit infused with resin composition). Suitably a top layer of sputter coating is removed by the surfacing. Suitably surfacing provides a substantially flat imagable surface. Surfacing suitably provides an imagable specimen sample.

### Method of Imaging the Imagable Specimen Sample

Having prepared the imagable specimen sample, the sample is suitably imaged using appropriate imaging techniques and apparatus. The imaging apparatus may suitably comprise, integrate, or be otherwise associated with automated handling machinery. Such automated handling machinery may suitably convey and manipulate the imagable specimen sample before, during, and after imaging.

### Imaging and the Imaging Apparatus

Suitably an imagable specimen sample is imaged using an appropriate imaging technique, suitable a technique which exposes the imagable specimen sample (or a part thereof—e.g. a section) to radiation.

### Radiation

Any radiation suitable for use with the imagable specimen sample may be used. Suitably resin compositions are formulated for exposure/imaging with particular radiation, so the radiation may be selected based on the resin compositions in question.

Suitably the radiation is radiation of a sufficiently high energy to cause inelastic scattering of secondary electrons from the imagable specimen sample. For instance, suitably the radiation causes imagable levels of secondary electrons to be inelastically scattered from a sample of araldite (or other such polymers defined herein). Such inelastic scattering of secondary electrons suitably produces detectable levels of secondary electrons to allow for imaging to occur on the basis of such inelastic scattering.

Suitably the radiation is either electromagnetic radiation (especially ultraviolet) or an electron beam.

In a particular embodiment, the radiation is electron beam radiation (i.e. provided by an electron beam). The electron beam radiation may be a focused, targeted beam, thereby allowing direct irradiation of the relevant part(s) of the imagable specimen sample. Suitably the electron beam is focused to a spot with a diameter between 0.1 nm and 20 nm, more suitably between 0.5 nm and 5 nm. As such, imaging of the imagable specimen sample using an electron beam may involve directly exposing the imagable specimen sample to the beam. The electron beam radiation (e.g. primary electrons) suitably has an initial energy (or acceleration voltage) between 0.01 and 400 keV, suitably 0.05 to 300 keV, suitably 0.1 to 100 keV, suitably 1 to 30 keV more suitably between 1 and 10 keV, more suitably between 1 and 5 keV, most suitably between 1.5 and 3.5 keV. The electron beam suitably has a current of at least 100 pA/beam. The electron beam suitably has a current between 25 pA/beam and 100 nA/beam (nA=nano amperes, pA=pico amperes), suitably between 100 pA/beam and 50 nA/beam, suitably between 270 pA/beam and 10 nA/beam, suitably between 1 nA/beam and 10 nA/beam. Where the electron beam is employed as a focused, targeted beam, suitably the electron beam interacts with the resin component with a dose below 100000 μC/cm² (uC=unit of electronic charge, uC/cm²=electronic charge per unit area), suitably below 10000 μC/cm², most suitably below 5000 μC/cm². The write speed may be as low as 500 μC/cm², but is suitably greater than or equal to 500 μC/cm², suitably greater than or equal to 1000 μC/cm². In a particular embodiment, the radiation is an electron beam having energies between 1.5 and 15 keV, a current between 500 pA/beam and 2.5 nA/beam, and an electron dose below 5000 μC/cm². The present invention allows the use of low energy electron beams, thereby minimizing damage to the imagable specimen sample. An electron beam can be generated by methods well known to those skilled in the art.

In an embodiment, the radiation is ultraviolet radiation, suitably having a wavelength between 10 and 400 nm. Where ultraviolet radiation is used for exposure, the imagable specimen sample (or the resin composition used in its preparation) may comprise additional ingredients (e.g. a photoacid and/or photocatalyst) to facilitate secondary electron generation and/or ultimate imaging. The ultraviolet radiation suitably causes the production of secondary electrons during imaging (in much the same manner as with electron beam radiation, albeit the secondary electrons may be generated more indirectly), especially in the presence of a secondary electron generator as defined herein. The ultraviolet radiation can be generated by methods well known to those skilled in the art. The ultraviolet radiation may be extreme-ultraviolet (EUV), suitably having a wavelength between 10 and 124 nm, suitably between 10 and 20 nm, suitably between 11 and 15 nm (most suitably about 13.4 nm). Alternatively, the ultraviolet radiation may suitably have a wavelength between 150 and 240 nm, suitably between 180 and 210 nm, suitably between 190 and 200 nm, suitably about 193 nm.

### Detection

Imaging suitably comprises detecting scattered radiation from the imagable specimen sample. The scattered radiation in question is suitably the result of the imagable specimen sample being exposed to a relevant radiation source (e.g. eBeam). Such scattered radiation may suitably include reflected radiation (e.g. reflected primary electrons) resulting from elastic scattering, secondary electrons resulting from inelastic scattering, and/or emitted electromagnetic radiation. Each of these scattered forms of radiation may be (separately) detected by respective purpose-built detectors. Detection may (also) involve measuring absorbed energy from the incident radiation. Any or all of these detection methods may be employed to generate images of the imagable specimen sample (or part(s) thereof).

Suitably the imaging involves detection of inelastically scattered secondary electrons. As such, any imaging apparatus suitably comprises a detector, which suitably is a detector of inelastically-scattered secondary electrons. Suitably the detection of inelastically scattered secondary electrons is the basis or primary basis of detection used for imaging.

Suitably the one or more detectors produce detection signals which may be processed to produce a visualisable image of the imagable specimen sample. The imaging process may involve amplification of such detection signals.

### Imaging Apparatus

Suitably the imaging apparatus comprises a radiation source, most suitably an electron beam source. Suitably the electron beam is an electron beam as defined herein.

Suitably the imaging apparatus comprises a scanning electron microscope (SEM) or a transmission electron microscope (TEM). As such, imaging may suitably comprise performing scanning electron microscopy (SEM) or a transmission electron microscopy (TEM) upon the imagable specimen sample (or part(s) thereof).

In a preferred embodiment, the imaging apparatus comprises a scanning electron microscope (SEM), and imaging is thus performed via scanning electron microscopy. SEM apparatus and imaging methods are well known in the art, and typically employ an electron beam, suitably thermoionically emitted form an appropriate electron gun (e.g. with a tungsten filament cathode). An SEM suitably produces an electron beam with energies ranging from 0.2 keV to 40 keV. Suitably the electron beam is focused to a spot of about 0.5-5 nm in diameter. Suitably the electron beam scans a surface of the imagable specimen sample, suitably a surface exposed via a particular section of the imagable specimen sample.

### Automated Handling

Suitably the overall imaging process involves automated (suitably robotic) handling of the imagable specimen sample. The automated handling suitably involve conveying the imagable specimen sample to any relevant stations in the imaging process. The automated handling also suitably involves sectioning or cutting, suitably sequential section/cutting between multiple imaging events (e.g. during 3D imaging where several sections of the imagable specimen sample are imaged throughout its depth), of the imagable specimen sample to expose a fresh surface for imaging. Special sectioning knives (usually diamond or glass knives with an appropriate profile) are suitably used for each sectioning event. Suitably each sectioning event removes (and ultimately disposes of) a thin layer (e.g. a top surface, which may have been imaged) from the imagable specimen sample. The thin layer is suitably a discard layer. Each discard layer suitably has a thickness between 1 and 50 nm, suitably between 4 and 30 nm, more suitably between 10 and 20 nm. Suitably the thickness of the discard layer is predetermined so that the underlying surface of the imagable specimen sample exposed following removal of the discard layer is (substantially) unperterbed by any radiation to which the specimen was exposed prior to removal of the discard layer. Alternatively, when using self-healing components in accordance with the invention, thinner discard layers may be used since radiation damage underlying the initially-imaged surface is suitably repaired as the damaged is caused.

Suitably the overall imaging process comprises one or more (preferably a plurality of) sectioning and imaging cycles, wherein each cycle suitably comprises sectioning the imagable specimen sample (suitably removing a discard layer which has been optionally imaged) and imaging the sectioned imagable specimen sample. In this manner, an image pattern of each section of the imagable specimen sample may be computationally synethesised to produce a 3-dimensional image of the imagable specimen sample.

Most suitably, the imaging apparatus is an ultramicrotome, which is well known in the art, and already used in the imaging of biopsy samples.

### Specimen

In principle, the specimen may be any suitable article or substrate. Various articles and substrates may be transformed, suitably as defined herein, into imagable specimen samples utilising the materials and techniques provided by the present invention. For instance, any material capable of incorporating or otherwise sorbing (whether physically, chemically, or both) a secondary electron generator as defined herein may be used and the benefits of the invention realised therewith.

Suitably the specimen is a flexible or malleable material, suitably a specimen in need of hardening/setting prior to imaging.

Though the specimen could be any suitable article or substrate, particular those with facets of interest (whether 2-dimensional or 3-dimensional surface facets, bulk facets, and/or non-surface internal facets) on a nanoscopic and/or microscopic scale (i.e. which are invisible to the “naked eye”), most suitably the specimen is an article or substrate comprising a non-homogenous physical structure (at least on a nanoscopic and/or microscopic scale) throughout its bulk, suitably with 3-dimensional facets of interest. In a particular embodiment, the specimen is a biological sample, suitably a biological tissue sample, suitably a histological sample (or biopsy), for instance, such as a biological tissue sample originally obtained by an incisional biopsy. Suitably, the specimen is a substrate prone to degradation over time, and suitably requires one or more preservation treatments to preserve the imagable structure of the specimen (e.g. histological architecture of tissue cells).

### Imaging Preparation Composition and Resin Composition

The invention provides an imaging preparation composition, which may optionally be a resin composition. The composition suitably comprises a secondary electron generator. Alternatively or additionally the composition suitably comprises a self-healing component. In a particular embodiment, the composition comprises both a secondary electron generator and a self-healing component.

Where the imaging preparation composition additionally comprises a resin component (e.g. resin polymer), the imaging preparation composition may be described as a resin composition. Unless stated otherwise or clearly incompatible in a given context, herein the term “resin composition” may be used interchangeably with the term “imaging preparation composition”.

Suitably a resin composition is utilised where the specimen to be imaged is flexible and/or malleable such that its physical structure requires rigidification for optimal imaging (especially where 3D imaging is required following the taking of multiple sections). However, where the specimen is already suitably rigid, a resin component may not be required. Under such circumstances, the self-healing component may be selected to complement material(s) of the specimen itself (e.g. so that the self-healing component may chemically-react in situ with any damaged specimen produced during the imaging process). On the other hand, where a resin component is incorporated, typically any self-healing component is selected to complement the chemistry of the resin component itself (e.g. so that the self-healing component may chemically-react in situ with any damaged resin component produced during the imaging process).

Suitably, prior to any curing, hardening or setting, the imaging preparation composition or resin composition is fluidic, preferably a liquid, most suitably a solution, dispersion, emulsion, and/or suspension of the stipulated ingredients. Such liquid compositions allow for immersion of a specimen therein in order to sorb the composition within the specimen to produce an imagable specimen sample.

Where the specimen is a biological sample, especially a biological tissue sample, most suitably the imaging preparation composition is a resin composition, comprising: a resin component; and a secondary electron generator and/or a self-healing component. In a particular embodiment, the resin composition comprises a resin component; a secondary electron generator and a self-healing component.

Suitably, after any curing, hardening or setting (suitably after treating a specimen with a fluid imaging preparation composition) the imaging preparation composition or resin composition is (substantially) solid or otherwise has a sufficiently high viscosity so as to be immobile. Such solid compositions allows for encapasulation of and rigidification of a specimen sample.

During imaging (e.g. where an imagable specimen sample incorporates the resin composition), the presence of the secondary electron generator suitably amplifies the yield of inelastically-scattered secondary electrons relative to a comparative system without the secondary electron generator. The degree of amplification depends on the secondary electron generator utilised, and can be predicted on the basis of the validated model (Monte-Carlo model) set forth herein.

During imaging (e.g. where an imagable specimen sample incorporates the resin composition), the resin component (or parts thereof, whether at an exposed/imaged surface or within the bulk underlying the exposed/imaged surface) may incur chemical damage from incident radiation (e.g. primary electrons from an eBeam), from elastically-backscattered/reflected incident radiation, and/or from inelastically-scattered secondary radiation (e.g. secondary electrons). Such chemical damage can, in the absence of a suitable repair mechanism, manifest as physical damage (e.g. since chemically-damaged sites may become softer, more porous, etc.) which would lead to unrepresentative images being produced during imaging. The presence of a self-healing component within the resin composition, though not necessarily preventing chemical damage caused by imaging, suitably prevents or inhibits consequential physical damage by chemically reacting with chemically-damaged species of the resin component to yield products that at least retain a degree of physical integrity so that images of the corresponding imagable specimen sample remain substantially representative of their pre-damaged form.

The resin composition may comprise additional ingredients (e.g. a photocatalyst, photoacid generator—see below) which facilitate production of or produce electrons upon exposure to electromagnetic radiation (suitably visible or UV-radiation). This enables the resin compositions of the invention to be applied to non-eBeam imaging techniques, for instance, a technique involving eUV radiation.

Suitably the resin composition is (substantially) free of any particulate matter. Suitably the resin composition is (substantially) free of any nanoparticles, especially of any metal(0) nanoparticles.

Suitably the resin composition comprises a solvent. Suitably the resin composition comprises between 20 and 99 wt % solvent, suitably between 50 and 97 wt %, more suitably between 80 and 95 wt % solvent. As such, the resin composition suitably comprises between 1 and 80 wt % non-solvent components, suitably between 3 and 50 wt % non-solvent components, more suitably between 5 and 20 wt % non-solvent components. Suitably the resin composition is a solution, suitably which is free of any dispersed or suspended particulate matter. In some embodiments, the resin component may itself serve as a solvent.

As explained in the relevant section below, a resin component may in some embodiments comprise multiple resin-forming ingredients (e.g. resin, hardener, and/or accelerator) and the skilled person is capable of selecting the correct balance of each ingredient for optimal performance of the resin component. Unless stated otherwise, reference to a “resin component” or an amount or concentration thereof suitably refers to the combination of any resin-forming ingredients thereof (e.g. the sum of concentrations/amounts).

Suitably the resin composition comprises 50-99 wt % resin component, suitably 70-98 wt %, more suitably 85-95 wt %, most suitably greater than or equal to 90 wt %. In a particular embodiment, the resin component comprises a synthetic resin (e.g. epoxy resin such as araldite M) and a hardener (e.g. DDSA), and optionally an accelerator (e.g. BDMA).

Suitably, the imaging preparation composition/resin composition comprises 0.01-20 wt % secondary electron generator(s), suitably 0.1-10 wt %, suitably 1-5 wt %, suitably 4-6 wt %.

Suitably, the imaging preparation composition/resin composition comprises 0.01-30 wt % self-healing component(s), suitably 0.1-20 wt %, suitably 1-10 wt %, suitably 4-6 wt %.

In a particular embodiment, the resin composition comprises:
50-99 pbw resin component; and
0.01-20 pbw secondary electron generator(s) and/or 0.01-30 pbw self-healing component(s).

In a particular embodiment, the resin composition comprises:
70-98 pbw resin component; and
0.1-10 pbw secondary electron generator(s) and/or 0.1-20 pbw self-healing component(s).

In a particular embodiment, the resin composition comprises:
85-95 pbw resin component; and
1-6 pbw secondary electron generator(s) and/or 1-10 pbw self-healing component(s).

In a particular embodiment, the resin composition comprises:
85-95 pbw resin component; and
4-6 pbw secondary electron generator(s) and/or 4-6 pbw self-healing component(s).

### Resin Component

In the context of the invention, a resin component is any component (or set of components) capable (or that was previously capable, prior to solidification) of undergoing a transition from a (substantially) fluid or liquid state to a (substantially) solid state. Such a transition may be externally facilitated (e.g. a curing/hardening process), though such a transition may be a slow curing process that takes place at SATP.

Herein, reference to a resin component suitably refers to the resin component regardless of its physical form and any chemical transformations that occur during state transitions. As such, the resin component may be a part of a fluid resin composition or its solidified counterpart, albeit chemical and physical changes will have taken place. The exact species in question will be readily apparent to the skilled person by virtue of context.

The resin component may be or comprise a natural resin component (e.g. plant resin) and/or a synthetic resin component (e.g. epoxy resin, suitably along with relevant hardener and optional accelerator), though most suitably the resin component is a synthetic resin component, especially where the specimen is a biological tissue sample.

The term “resin” may be used to describe one of two monomers of a thermosetting co-polymer (as per epoxy resin systems), whilst the other of two monomers is typically defined as a “hardener”—however, the combination may be considered a resin component both before and after setting. Where only one monomer is used in the formation of a thermosetting plastics polymer (e.g. acrylic resins such as PMMA formed by methylmethacrylate monomers), this one monomer is suitably referred to as a “resin”. A synthetic resin component generally comprises liquid monomers of thermosetting plastics.

The resin component may comprise one or more individual resin-forming ingredients, suitably two or more resin-forming ingredient. For instance, resins such as araldite/epoxy resin can be supplied as separate ingredients (at least one of which is liquid) which, when mixed together, eventually harden/set to form a final solidified resin (usually at room temperature). Sometimes such resins may be supplied pre-mixed in a ready-to-use form, though such mixtures are preferably stored under conditions which prevent premature curing/hardening. As such, a resin composition of the invention may be supplied as a single pre-mixed composition, or as a kit of two or more separate compositions which, when mixed together, collectively form a resin composition.

Where a resin component comprises two or more resin-forming ingredients, said resin-forming ingredients may be supplied separately, optionally as part of a kit (suitably along with other components or ingredients described herein in the context of the invention), although during use the relevant multiple resin-forming ingredients are mixed so as to produce a resin component, typically as part of a resin composition. It is the collective ingredients of the resin component that ultimately hardens to produce a solid resin component, though some of the resin-forming ingredients may not necessarily be incorporated into the final compound (e.g. polymer or co-polymer) responsible for the hardening. Thus, unless stated otherwise, wherever amounts are given in respect of a “resin component”, this suitably includes all of the relevant resin-forming ingredients, optionally excluding or including any accelerator(s). Thus, by way of example, a resin component may be considered to comprise all of araldite M, hardener DDSA, and optionally also an accelerator BDMA, and the weight of the resin component would be the sum total of all.

Synthetic resin components typically comprise two or more resin-forming ingredients, for example, a first resin-forming ingredient and a second resin-forming ingredient. The first resin-forming ingredient is suitably a first reactive monomer (often referred to as the “resin”, e.g. a reactive monomer, such as an epoxide, which ultimately forms the polymer backbone of a hardened resin component, e.g. an epoxy resin, such as araldite M or araldite CY212). The second resin-forming ingredient is suitably a hardener, which suitably reacts with the first reactive monomer to cause polymerisation of the first reactive monomer optionally co-polymerised with the hardener itself (in which case the hardener is a second monomer), though the hardener need not necessarily be incorporated in the final polymer. Additionally, the resin component may comprise a third resin-forming ingredient, for example, an accelerator which may serve to catalyse (and thus “accelerate”) a reaction between the first and second resin-forming ingredients. Various synthetic resin systems are known in the art, and the principles of the present invention extend to all types of synthetic resin components.

Synthetic resin components (especially the resin part—i.e. first resin-forming ingredient), like their natural plant resin counterparts, are suitably liquids (suitably viscous liquids) capable of hardening/setting (suitably permanently). However, the chemical underpinning to such hardening/setting is different to that for natural resins.

Typically, the resin component is or comprises a polymer or co-polymer (i.e. a resin polymer). However, in some embodiments, the resin component may be or comprise a non-polymer (e.g. a macromolecule, a complex, a suitable carrier compound or diluents, preferably a solid diluent).

The resin composition is suitably sufficiently mobile to permit its infusion into a specimen. Suitably, therefore, any resin component is suitably sufficiently mobile to permit its infusion into a specimen. A primary function of the resin component is to facilitate physical setting/hardening of an imagable specimen sample. As such, once infused within a specimen, the resin component may suitably be hardened/set (e.g. under appropriate conditions) to stabilize the physical form of the imagable specimen sample. Such setting/hardening may be facilitated by a variety of techniques known in the art, and may suitably resemble a curing process. In a particular embodiment, such setting/hardening is effected by the application of heat and/or radiation. In this manner, the resin component is suitably set/hardened in situ inside and/or around the specimen itself.

The resin component may be or comprise any resin polymer known in the art and suitable for its role during the preparation of an imaging sample.

The resin component, especially when substantially set/hardened, may be a radiation-sensitive material which undergoes transformation upon exposure to the relevant radiation (e.g. be it Ebeam or UV/visible). As such, the resin component may be a resist polymer, such as a resist polymer used in the art of lithography, for instance eBeam lithography or photolithography (e.g. a photoresist). Such a radiation-sensitive resin component, especially an eBeam-sensitive resin component, may suitably be vulnerable to damage during imaging, especially imaging with eBeam, though some or all of the damage may be caused by inelastically-scattered secondary electrons. Such damage may be (substantially) repaired by a self-healing component where said self-healing component is in close-proximity to or otherwise diffusible towards the damaged resin component.

The resin component (especially where resin-forming components are mixed together to form the resin component) suitably has a density greater than or equal to 0.8 g/cm³, suitably greater than or equal to 0.9 g/cm³, suitably greater than or equal to 0.95 g/cm³, suitably greater than or equal to 1.0 g/cm³. The resin component suitably has a density less than or equal to 2 g/cm³, suitably less than or equal to 1.5 g/cm³, suitably less than or equal to 1.3 g/cm³, suitably less than or equal to 1.2 g/cm³. Suitably the resin component has a lower density than the secondary electron generator, suitably at least 1.0 g/cm³ lower, suitably at least 2.0 g/cm³ lower.

The resin component suitably is or comprises a compound having an effective atomic number (Z_{eff}) less than or equal to 25. Suitably this Z_{eff} is less than or equal to 15, suitably less than or equal to 10, suitably less than or equal to 8, suitably less than or equal to 6. PMMA, which is a suitable resin component for use in accordance with the invention, has a Z_{eff} of 5.85 by virtue of the following calculation:
Using the monomeric unit “methylmethacrylate” (C₅H₈O₂ because this yields the same Z_{eff} as the polymer thereof), the relevant atoms and atomic numbers are:
   Z_{C}=6
   Z_{H}=1
   Z_{O}=8
The sum total of all atomic numbers in the molecule is:

(5×Z_{C})+(8×Z_{H})+(2×Z_{O})=30+8+16=54
α_{C}=30/54=0.556
α_{H}=8/54=0.148
α_{O}=16/54=0.296
The Z_{eff} calculated using the equation Z_{eff}=α_{C}Z_{C}+α_{H}Z_{H}+α_{O}Z_{O} is:

Z_{eff}=(0.556×6)+(0.148×1)+(0.296×8)

Z_{eff}=3.336+0.148+2.368=5.85

Araldite, another suitable resin component for use with the invention, is a two-ingredient resin and, as such, an overall Z_{eff} value for the resin component must be calculated by reference to and weighted by the relative proportions of each ingredient. However, since all such resins are organic-based, they generally have low overall Z_{eff} values as well as relatively low densities. Araldite suitably has a Z_{eff} value of 5.521.

Perhaps the most suitable synthetic resins for use as a resin component are thermosetting plastic resins, albeit “thermosetting” generally refers to a product resulting from a polymerisation reaction during formation of the synthetic resin component.

The synthetic resin component may comprise an epoxy resin component, a polyurethane resin component, an acrylic resin component, an acetal resin component, or an unsaturated polyester resin component. In an embodiment, the resin component is or comprises an epoxy resin, for example, Araldite®, Epon®, or Durcupan®. In an embodiment, the resin component is an acrylic resin.

The resin component may be or comprise:

poly(methylmethacrylate), poly(1-naphthyl methacrylate), poly(1-vinylnaphthalene), poly(2,6-napthalenevinylene), poly(2-chlorostyrene), poly(2,6-dichlorostyrene), poly(2-vinylthiophene), poly(N-vinylphthalimide), poly(vinyl phenyl sulphide), polyhydroxystyrene or any suitable mixture or copolymer thereof.

In a particular embodiment, the resin component comprises: a first resin-forming ingredient, a second resin-forming ingredient, and optionally a third resin-forming ingredient. The first resin-forming ingredient is suitably a synthetic resin, most suitably an epoxy resin, most suitably 2-((4-(tert-butyl)phenoxy)methyl)oxirane. The second resin-forming ingredient is suitably a hardener, suitably dodecenylsuccinic anhydride (DDSA). When present, the third resin-forming ingredient is suitably an accelerator (or catalyst) which suitably accelerates the rate of reaction between the first and second resin-forming ingredient. Suitably the accelerator is N,N-dimethylbenzylamine (BDMA).

In a particular embodiment, the resin component comprises: 50-500 pbw synthetic resin, 50-500 pbw hardener, and optionally 1-50 pbw accelerator. In a particular embodiment, the resin component comprises: 150-300 pbw synthetic resin, 150-300 pbw hardener, and optionally 5-20 pbw accelerator. In a particular embodiment, the resin component comprises: 200-250 pbw synthetic resin, 200-250 pbw hardener, and optionally 10-15 pbw accelerator.

Suitably, excluding any solvents (e.g. with a bp 120° C., suitably bp 100° C., such as MTBE, acetone, etc.), the resin composition comprises at least 50 wt % resin component (collectively where multiple resin-forming ingredients present), suitably at least 80 wt %, suitably at least 85 wt %, more suitably at least 90 wt %, most suitably at least 94 wt % thereof. Suitably, excluding any solvents (e.g. with a bp 120° C., suitably bp 100° C.), the resin composition comprises at most 99.5 wt % resin component (collectively where multiple resin-forming ingredients present), suitably at most 99 wt %.

### Secondary Electron Generator

The secondary electron generator is suitably a species which generates (and suitably scatters) secondary electrons, suitably in response to exposure to primary radiation (e.g. from an electron beam and/or other high energy radiation, e.g. eUV). In particular, the secondary electron generator suitably inelastically scatters secondary electrons in response to impact(s) by primary electrons having sufficient energy to ionize the secondary electron generator. Thus the secondary electron generator suitably generates secondary electrons, as ionization products, in response to exposure to the primary radiation. The primary radiation is suitably an electron beam or electromagnetic radiation. The electromagnetic radiation may suitably be ionizing radiation (e.g. high UV, ˜13.4 nm), and the secondary electrons may therefore be photoelectrons resulting from the directly ionization of the secondary electron generator. Alternatively, the electromagnetic radiation may suitably be non-ionizing radiation (e.g. low UV, ˜193 nm), and secondary electrons may be generated indirectly, potentially following the intervening generation of a primary electron from a photoacid generator which thereafter collides with the secondary electron generator to precipitate a secondary electron. As such, a photoacid cannot be considered a secondary electron generator in the context of the present invention.

The secondary electron generator and/or compound(s) thereof by definition yield more secondary electrons (i.e. have a higher secondary electron omission yield) than the (cured) resin component, suitably at least by a factor of 2, suitably at least by a factor of 3, suitably at least by a factor of 4.

Secondary electrons generally scatter “laterally” (suitably 80° from an incident beam), thereby spreading the “write” effect, increasing the sensitivity of a resin and thereby decreasing the “dose” required from the primary radiation.

Generally speaking, a primary electron will undergo elastic and inelastic collisions as it passes through a given material (e.g. a hardened resin composition), and lose energy along the way as it collides with atoms in its path. Energy loss rates increase if:
(a) the number of collisions are increased or mean free path is decreased; and/or
(b) the “stopping power” of the material is increased.

The number of collisions can be increased by increasing the scattering cross section of a given material. Mean free path can be decreased by using denser materials. “Stopping power” can be increased by using materials having a higher “mean ionization potential” (where the term “mean ionization potential” is used as per the Bethe equation, and as approximated by Bloch:

I=(10 eV)×Z

where I is mean ionization potential and Z is the atomic number of atoms in a material. The more effectively a material absorbs the energy of a primary electron, the more ionization events will occur and the more secondary electrons will be generated. Therefore, secondary electron generators with high density and/or high “mean ionization potentials” (generally high atomic numbers as per Bloch approximation) are especially suitable for use in the present invention.

The secondary electron generator suitably is or comprises a compound having an effective atomic number (Z_{eff}) greater than or equal to 15 (where optionally the Z_{eff} calculation excludes any solvates, having a boiling point less than or equal to 150° C. at 100 kPa pressure, associated with said compound, suitably any solvates having a boiling point less than or equal to 120° C. at said pressure, suitably 105° C. at said pressure). Suitably this Z_{eff} is greater than or equal to 18, suitably greater than or equal to 23, suitably greater than or equal to 25, suitably greater than or equal to 30, suitably greater than or equal to 32, suitably greater than or equal to 40. Suitably this Z_{eff} is less than or equal to 70, suitably less than or equal to 66, suitably less than or equal to 61, suitably less than or equal to 60, suitably less than or equal to 55. The secondary electron generator or compound(s) thereof suitably has a higher Z_{eff} than the resin component (particularly a hardened resin component), suitably at least 10 units higher, suitably at least 20 units higher, suitably at least 30 units higher.

Suitably, the secondary electron generator is or comprises a compound having a molecular weight less than or equal to 500 g/mol.

The secondary electron generator suitably is or comprises a metal compound. It cannot be or comprise an elemental metal (i.e. metal(0)). In fact, the resin composition is suitable (substantially) free of any metal (0)). Suitably any metal species of the metal compound are metal ions.

References to the secondary electron generator or compound(s) thereof generally relate to the pre-mixed (i.e. prior to mixing with other components of the resin composition) form thereof (e.g. in terms of any cationic-anionic associations in relevant metal compound(s)). It will be appreciated by those skilled in the art that, upon mixing with other components of the resin composition (and/or after immersing, curing/hardening, exposing, and/or imaging), any relevant cations and anions of metal compound(s) may, in some embodiments (though not all), dissociate and possibly become associated with other counterions and/or ligands. Therefore, references to a resin composition (or indeed a cured/hardened form thereof) suitably indicates a resin composition “formed by” (or derived from) mixing the relevant compound(s) with any other ingredients of the resin composition or “formed by” curing, exposing, and/or imaging the relevant product. It is straightforward for those skilled in the art, using standard techniques, to determine the input compound(s) from a resin composition or a cured-, exposed-, or imaged-product thereof.

The compound(s) of the secondary electron generator suitably has a density greater than that of the (cured) resin component. The compound(s) of the secondary electron generator suitably has a density greater than or equal to 1.7 g/cm³, suitably greater than or equal to 2 g/cm³, suitably greater than or equal to 2.5 g/cm³, suitably greater than or equal to 3 g/cm³, suitably greater than or equal to 4 g/cm³, more suitably greater than or equal to 4.1 g/cm³, suitably greater than or equal to 4.5 g/cm³, more suitably greater than or equal to 4.7 g/cm³, most suitably greater than or equal to 5 g/cm³. The compound(s) of the secondary electron generator suitably has a density less than or equal to 9 g/cm³, suitably less than or equal to 8.5 g/cm³, suitably less than or equal to 8 g/cm³. In a particular embodiment, the compound(s) of the secondary electron generator suitably has a density between 3.5and 8.3 g/cm³. Suitably the density is at least 2 times higher than the density of the resin component, suitably at least 3 times higher.

Suitably, the compound(s) of the secondary electron generator have a mean ionization potential (i.e. employing the “stopping power” meaning, suitably as provided by the well-known Bethe equation and the Monte Carlo model described herein and elsewhere) of 200 eV, suitably 300 eV.

Suitably the compound(s) has a low mean free path (λ)—i.e. the distance between successive electron collisions is low. Suitably the compound(s) has a lower mean free path (λ) than the (cured) resin component. Suitably the compound(s) of the secondary electron generator has an elastic mean free path of less than or equal to 900 nm, suitably less than or equal to 100 nm, suitably less than or equal to 50 nm, suitably less than or equal to 825 nm. Suitably the compound(s) of the secondary electron generator has an inelastic mean free path of less than or equal to 825 nm.

Suitably the compound(s) has a high elastic scattering cross-section (σ)—i.e. the chances of a collision is high. Suitably the compound(s) has a higher elastic scattering cross-section (σ) than the (cured) resin component. Suitably the compound(s) of the secondary electron generator has an elastic scattering cross-section (σ) of greater than or equal to 7×10⁻¹⁹ cm/atom, suitably greater than or equal to 1×10⁻¹⁸, suitably greater than or equal to 2×10⁻¹⁷, suitably greater than or equal to 4×10⁻¹⁸, suitably greater than or equal to 7×10⁻¹⁸. Suitably the (cured) resin component has an elastic scattering cross-section (σ) of less than or equal to 1×10⁻¹⁸ cm/atom, suitably less than or equal to 7×10⁻¹⁹ cm/atom. In a particular embodiment, the compound(s) of the secondary electron generator has an elastic scattering cross-section (σ) of greater than or equal to 7×10⁻¹⁹ cm/atom, whereas the (cured) resin component has an elastic scattering cross-section (σ) of less than or equal to 7×10⁻¹⁹ cm/atom. In a particular embodiment, the compound(s) of the secondary electron generator has an elastic scattering cross-section (σ) of greater than or equal to 2×10⁻¹⁸ cm/atom whereas the (cured) resin component has an elastic scattering cross-section (σ) of less than or equal to 7×10⁻¹⁹ cm/atom.

Any, some, or all of the definitions relating to any of the aforesaid parameters (e.g. Z_{eff}, density, mean free path, scattering cross-sectioning, mean ionization potential/stopping power, electron emission yield) may suitably relate to a form of the compound(s) which excludes any solvates having a bp 150° C. at 100 kPa pressure, suitably 120° C., suitably 105° C., e.g. excluding hydrates. This is reasonable since such solvates may be removed during processing.

Suitably any metal compound(s) of the secondary electron generator comprises a metal species which has an oxidation state of +1 or higher, suitably +2 or higher, suitably +3 or higher. Suitably any metal compound(s) of the secondary electron generator comprises a metal species which has an oxidation state of +4 or lower. Suitably any metal compound(s) of the secondary electron generator comprises a metal species which has an oxidation state of +3.

Suitably any metal compound(s) of the secondary electron generator comprises a single metal species or otherwise a predominant metal species (i.e. metal species constituting at least 50 wt % of the total metal species, suitably at least 80 wt %, suitably at least 90 wt %, suitably at least 95wt %). The metal species or metal ions (whether single or predominant) of such metal compound(s) of the secondary electron generator suitably have an oxidation state of +1 or higher, suitably +2 or higher, suitably +3 or higher. The metal species or metal ions (whether single or predominant) of such metal compound(s) of the secondary electron generator suitably have an oxidation state of +4 or lower. The metal species or metal ions (whether single or predominant) of such metal compound(s) of the secondary electron generator suitably have an oxidation state of +3. In an embodiment, the metal species or metal ions of such metal compound(s) of the secondary electron generator have an oxidation state of +2.

Any metal compound(s) of the secondary electron generator suitably comprises a metal species (or a single or predominant metal species) having an atomic number (Z) greater than or equal to 21 (i.e. scandium or heavier). Any metal compound(s) of the secondary electron generator suitably comprises a metal species (or a single or predominant metal species) having an atomic number (Z) greater than or equal to 22 (i.e. titanium or heavier). Any metal compound(s) of the secondary electron generator suitably comprises a metal species (or a single or predominant metal species) having an atomic number (Z) greater than or equal to 39 (i.e. yttrium or heavier). Any metal compound(s) of the secondary electron generator suitably comprises a metal species (or a single or predominant metal species) having an atomic number (Z) greater than or equal to 49 (i.e. indium or heavier). Any metal compound(s) of the secondary electron generator suitably comprises a metal species (or a single or predominant metal species) having an atomic number (Z) greater than or equal to 57 (i.e. lanthanum or heavier). Any metal compound(s) of the secondary electron generator suitably comprises only metal species (or a single or predominant metal species) having an atomic number (Z) less than or equal to 82 (i.e. lead or lighter). Any metal compound(s) of the secondary electron generator suitably comprises only metal species (or a single or predominant metal species) having an atomic number (Z) less than or equal to 80 (i.e. mercury or lighter). The metal species of the metal compound(s) may suitably be a d-block, p-block, or f-block metal species, or a mixture thereof. Suitably the metal compound(s) is non-radioactive.

Suitably the secondary electron generator is or comprises a metal halide, or a complex thereof (e.g. HAuCl₄). Suitably the secondary electron generator is a metal (I), metal (II), metal (III), or metal (IV) halide, or a complex thereof. Suitably the secondary electron generator is a metal (III) halide or a metal(I) halide, or a complex thereof. Suitably the secondary electron generator is a metal chloride, suitably a metal (I), metal (II), metal (III), or metal (IV) chloride. Suitably the secondary electron generator is a metal chloride, suitably a metal (I) or a metal (III) chloride.

The secondary electron generator may be a metal(II) halide (e.g. HgCl₂), or a complex thereof. In a particular embodiment, the secondary electron generator is a metal(II) chloride.

The secondary electron generator may suitably be selected from the group including, AlCl₃, TiCl₃, TiCl₄, CrCl₃, GaCl₃, YCl₃, MoCl₃, AgCl, InCl₃, SbCl₃ HfCl₃ TaCl₃, WCl₃, OsCl₃, IrCl₃, AuCl, AuCl₃, HAuCl₄, HgCl₂, CeCl₃, NdCl₃ ErCl₃, or any suitable complex (including any suitable salt or salt complex) thereof. In a particular embodiment, the metal compound is chloroauric acid (hydrogen chloroaurate, HAuCl₄) or the hydrate thereof (HAuCl₄.4H₂O). In another embodiment, the metal compound is sodium chloroaurate (NaAuCl₄) or a hydrate thereof (e.g. NaAuCl₄.2H₂O). In a particular embodiment, the metal compound is a mercury dichloride.

In a particular embodiment, the secondary electron generator is a gold-based compound (preferably a compound comprising gold(III) species). In a particular embodiment, the secondary electron generator is a mercury-based compound (preferably a compound comprising mercury(II) species). In a particular embodiment, the secondary electron generator is an indium-based compound (preferably a compound comprising indium(III) species). In a particular embodiment, the secondary electron generator is an yttrium-based compound (preferably a compound comprising yttrium (III) species). In a particular embodiment, the secondary electron generator is a titanium-based compound (suitably a compound comprising titanium (IV) species).

Suitably the secondary electron generator is inert to any resin component or polymer. Suitably the secondary electron generator is non-oxidising with respect to the resin component. Suitably the secondary electron generator is non-reducing with respect to the resin component. If the secondary electron generator is reactive with the resin component then the secondary electron generator can lose some or all of its capacity to generate secondary electrons.

Suitably, the secondary electron generator is less oxidizing than compounds, such as osmium tetroxide, traditionally used in the fixing and/or staining of histological samples. A secondary electron generator that is too oxidizing under a given set of conditions may be liable to undergo premature chemical transformations that could compromise its function during any imaging process. Suitably, the secondary electron generator is free of any species (be them metal ions, such as Hg²⁺ of HgCl₂, or metal complexes, such as AuCl₄⁻ of NaAuCl₄) having a highest standard electrode potential (i.e. the most positive redox voltage possible for the given oxidant species—since some species have more than one possible half equation and more than one redox potential corresponding to each half equation) greater than or equal to +1.6 V, suitably free of any species having a highest standard electrode potential greater than or equal to +1.2V, suitably free of any species having a highest standard electrode potential greater than or equal to +1.0V, suitably greater than or equal to +0.90V, suitably greater than or equal to +0.60V, suitably greater than or equal to +0.30V, suitably greater than or equal to +0.20V.

Suitably, the secondary electron generator may be as defined herein, with a proviso that the secondary electron generator is not (or is free of any compound(s) selected from the group consisting of):
osmium tetroxide, uranyl acetate, ruthenium tetroxide, phosphotungstic acid, ammonium molybdate, cadmium iodide, carbohydrazide, ferric chloride, hexamine, indium trichloride, lanthanum nitrate, lead acetate, lead asparate, lead citrate, lead(II) nitrate, periodic acid, phosphomolybdic acid, potassium ferricyanide, potassium ferrocyanide, ruthenium red, silver nitrate, silver proteinate, sodium chloroaurate, thallium nitrate, thiosemicarbazide, uranyl nitrate, and vanadyl sulfate.

Suitably the secondary electron generator may be free of mercury(II) chloride.

Suitably, notwithstanding any solvates (which are excluded from consideration), the secondary electron generator is (substantially) free of any metal compounds comprising an oxygen atom. Suitably, notwithstanding any solvates (which are excluded from consideration), the secondary electron generator is (substantially) free of any metal compounds comprising an atom with an atomic number less than or equal to 9, suitably less than or equal to 16.

The secondary electron generator is suitably an anhydrous metal compound. Suitably the metal compound of the secondary electron generator has a water content of less than or equal to 0.1 wt %, suitably less than or equal to 0.05 wt %, suitably less than or equal to 0.01 wt %, suitably less than or equal to 0.001 wt %. It is thought that higher water content can have an adverse effect on the secondary electron generation capacity, possible by virtue of a density effect. However, in some embodiments, a secondary electron generator metal compound may be a solvate, e.g. a hydrate.

The secondary electron generator is suitably non-particulate, especially within the resin composition where it is suitably dissolved within the solvent. The secondary electron generator is suitably soluble in the resin composition. This enables its uniform distribution within the resin composition(s) ultimately used.

Any of the aforementioned metal compound(s) may be a complex thereof.

Excluding any solvents (e.g. having a bp ≤120 C, suitably bp ≤100 C), suitably the secondary electron generator constitutes at least 0.05 wt % of the resin composition, suitably at least 0.5 wt %, suitably at least 1 wt %, suitably at least 2 wt %. Suitably the secondary electron generator constitutes at most 20 wt % of the resin composition, suitably at most 10 wt %, suitably at most 6 wt % (again all excluding solvents). In a particular embodiment, the resin composition comprises 4-6 wt % secondary electron generator (again all excluding solvents).

The secondary electron generator may be a single compound (or complex) or a mixture of compounds (and/or complexes). References herein to “a secondary electron generator” may refer to a single compound, which is thus designated as the secondary electron generator.

Suitably, the secondary electron generator is dispersed through the resin composition, suitably in a substantially homogenous manner (i.e. rather than being localized), whether the resin composition is in its fluid state (i.e. pre-cured) or post-cured state.

A secondary electron generator may be included within existing resin compositions to provide the benefits achieved by the present invention. As such, appropriate retrofitting may enhance existing resin technologies, especially those used in the art of biological tissue sample imaging, particularly with SEM or TEM.

### Self-Healing Component

The imaging preparation compositions, resin compositions, imagable specimen samples, kits of parts, and/or associated methods may suitably involve or comprise a self-healing component. The inclusion of such a self-healing component can contain/reduce collateral damage caused by incident radiation and/or secondary electrons during imaging, since self-healing components can immediately repair structurally-damaged parts of the imagable specimen sample by essentially tying up “loose ends” (formed as a result of bond breakages), whether the “loose ends” are tied together or tied to an auxiliary anchor.

Including a self-healing component within an imaging preparation composition of resin composition of the invention, with or without a secondary electron generator, can reduce sample damage beneath a surface being imaged. Reducing such damage allows for even thinner sectioning when taking multiple images of multiple surfaces to obtain 3D image of the imagable specimen sample, thereby improving image quality. Furthermore, such self-healing can allow for multiple imaging of the same surface without loss of image quality. This potentially allows for long-term filing of imagable specimen samples, which may be of interest to police services, forensic laboratories, and the like.

Any suitable self-healing component may be used, though most advantageously the self-healing component is judiciously selected for maximum compatibility with the radiation source and relevant resin component.

The self-healing component suitably is or comprises a compound capable of reacting in situ with (especially when part of an imagable specimen sample) a radiation-damaged material, especially a radiation-damaged polymer or co-polymer. Suitably the self-healing component is or comprises a compound capable of reacting (suitably in situ) with bond scission products. The self-healing component suitably is or comprises a compound capable of reacting (suitably in situ) to bond together at least two fragments of a molecule (e.g. a polymer or co-polymer) resulting from (formed by/following) bond scission (suitably also in situ, as a result of radiation damage or damage from scattered electrons or radiation). Suitably the compound of the self-healing component is capable of reacting to replace a previously existing bond between at least two fragments that has been broken. Suitably the compound of the self-healing component reacts to bridge together the at least two fragments.

Suitably, the self-healing component may be any suitable compound or compounds capable of reacting with a radiation-damaged (e.g. eBeam-damaged) form of the resin component (especially a resin component comprising a polymer or co-polymer that may be fragmented when exposed to high-energy radiation). Suitably the self-healing component is capable of reacting with the radiation-damaged resin component (especially via atom(s) or group(s) affected by radiation-induced bond scission/breakage, for instance, terminal groups derived from homolytic cleavage of a polymeric linkage or cross-linkage), most suitably to replace a bond broken with one or more new bonds, most suitably to join together molecular or polymeric fragments (resulting from radiation-induced fragmentation) to produce a larger molecule (i.e. which will be inherently more solid and have a higher melting point). Such an in situ repair mechanism mitigates against polymers becoming fragmented and over-softened or fluidised during irradiation, and thus better preserves the structural integrity and solidity of the imagable specimen sample, thereby providing better images.

Though the self-healing component is suitably a reactive species, within the image preparation composition, resin composition, or solidified form(s) thereof, suitably the self-healing component does not substantially react until the resin component is damaged to provide reactive species. Protecting the self-healing component from premature reaction can be achieved in a number of ways, including deliberate encapsulation within a material that is broken by radiation to release the self-healing component for reaction. Alternatively, the self-healing component could be a relatively inert component until relevant conditions prevail (e.g. radiation-induced radical initiation, for instance, through bond scission of the resin component). Such compounds may include alkenes and the like.

Most suitably, the self-healing component is or comprises a compound which is reactive with free-radicals. Suitably the compound of the self-healing component reacts with free-radicals to form a cross-linker. Suitably, the self-healing component is a cross-linker, suitably a cross-linker capable of reacting to form one or more cross-links within a single polymer or between two or more polymers). In a particular embodiment the self-healing component comprises a compound with a homolysable bond (e.g. alkene, alkyne, etc.). Most suitably the compound is an alkene (comprising one or more C═C double bonds) and/or an alkyne. The compound suitably comprises one or more alkenyl and/or alkynyl moieties. The compound comprises two or more alkenyl and/or alkynyl moieties, most suitably exactly two, most suitably exactly two alkenyl moieties. As such, the compound may be a dialkene, a diacrylate, and such like.

The self-healing component is suitably selected from: pentaerythritoltetraacrylate (PET), dipentaerythriolpentaacrylate (DPEPA), Pentaerythritol ethoxylate, Pentaerythritol propoxylate, ethylene glycol di(meth)acrylate or a derivative thereof (e.g. ethylene glycol diacrylate, Di(ethylene glycol) diacrylate, Tetra(ethylene glycol) diacrylate, Ethylene glycol dimethacrylate, Di(ethylene glycol) dimethacrylate, Tri(ethylene glycol) dimethacrylate), methylenebisacrylamide or a derivative thereof (e.g. N,N′-Methylenebisacrylamide, N,N′-(1,2-Dihydroxyethylene)bisacrylamide), divinylbenzene or a derivative thereof, 1,4-Bis(4-vinylphenoxy)butane.

In a particular embodiment, the self-healing component comprises a polyol-poly(alkyl)acrylate ester, wherein two or more alcohol groups of the polyol form an acrylate or an alkylacrylate ester. An alkylacrylate group may be a (1-12C)alkyl-acrylate group, most suitably methacrylate. The core polyol may be any suitable polyol. Most suitably the polyol is a carbohydrate or otherwise only contains C, H, and O atoms. The polyol may be a sugar or sugar alcohol, glycol, ethylene glycol, propylene glycol, and/or glycerol.

In a particular embodiment, the self-healing component is pentaerythritoltetraacrylate (PET). PET is a polyol-poly(alkyl)acrylate ester where the polyol is pentaerythritol wherein all four hydroxyl moieties are esterified to form acrylate esters.

The self-healing component is suitably a compound capable of reacting with at least two free radical species to form a cross-link there between.

The self-healing component suitably has a density greater than or equal to 0.8 g/cm³, suitably greater than or equal to 0.9 g/cm³, suitably greater than or equal to 0.95 g/cm³, suitably greater than or equal to 1.0 g/cm³. The self-healing component suitably has a density less than or equal to 2 g/cm³, suitably less than or equal to 1.5 g/cm³, suitably less than or equal to 1.3 g/cm³, suitably less than or equal to 1.2 g/cm³. Suitably the self-healing component has a lower density than the secondary electron generator, suitably at least 1.0 g/cm³ lower, suitably at least 2.0 g/cm³ lower.

The self-healing component suitably is or comprises a compound having an effective atomic number (Z_{eff}) less than or equal to 25. Suitably this Z_{eff} is less than or equal to 15, suitably less than or equal to 10, suitably less than or equal to 8, suitably less than or equal to 7. PET, which is a suitable resin component for use in accordance with the invention, suitably has a Z_{eff} of 6.03.

Desirably the self-healing component is selected to minimise secondary electron generation during imaging.

Excluding any solvents (e.g. having a bp ≤120 C, suitably bp ≤100 C), the resin composition suitably comprises at least 0.05 wt % of the self-healing component, suitably at least 0.5 wt %, suitably at least 1 wt %, suitably at least 2 wt %. Suitably the resin composition comprises at most 20 wt % self-healing compoinent, suitably at most 10 wt %, suitably at most 6 wt % (excluding solvents). In a particular embodiment, the resin composition comprises 4-6 wt % self-healing component (again excluding solvents).

When “excluding any solvents” for the purposes of determining weight concentrations, as per above and elsewhere herein, a resin component which happens to serve as a solvent (e.g. an epoxy resin such as araldite M) for other ingredients of the resin composition should not be excluded.

It is desirable to minimise the secondary electron generating capacity of either or both of the resin component and self-healing component.

### Solvent

Any suitable solvent system may be employed as a diluent for the resin composition. The solvent may, in fact, be a combination of one or more solvents. As such, references herein to a solvent may, unless stated otherwise, optionally include a mixture of solvents. Suitably the solvent dissolves the combination of solute components of the resin composition to thereby form a solution. Suitably the solvent is used within the resin composition in a proportion which dissolves the combination of non-solvent components therein to thereby form a solution. The resin composition is suitably a solution.

The dilution level can be varied to suit the system, and will depend entirely on the combination of ingredients, any solubility constraints, and the desired dilution level (e.g. for optimal casting of the resin). Suitably, however, the weight ratio of solvent(s) to resin component is between 10:1 and 100:1.

Suitably solvents include hexane, heptane, pentane, anisole, toluene, xylene, n-propanol, iso-propanol, acetone, dichloromethane, butyl acetate, tetrahydrofuran, dimethylformamide, ethyl acetate, diethyl ether, or a combination thereof. In a particular embodiment, especially in resin compositions, the solvent includes acetone and tert butyl methyl ether, suitably in a weight ratio of 1:1 to 1:100

In some embodiments, the primary solvent may be the resin component or an ingredient thereof (e.g. the epoxy resin portion in its pre-polymerised form). In such embodiments, any other solvents may merely be those used to initially mobilise one or more of the other ingredients/components of the resin composition to allow for the resin composition's formation.

### Specific Embodiments

In a particular embodiment, the imaging preparation composition or resin composition comprises:
(i) a secondary electron generator comprising a compound having an effective atomic number (Z_{eff}) greater than or equal to 15 (optionally where Z_{eff} excludes any solvates having a boiling point less than or equal to 150° C. at 100 kPa pressure); and
(ii) optionally a resin component.

In a particular embodiment, the imaging preparation composition or resin composition comprises:
(i) a self-healing component having an effective atomic number (z_{eff}) less than or equal to 15 (optionally where z_{eff} excludes any solvates having a boiling point less than or equal to 150° C. at 100 kPa pressure); and
(ii) optionally a resin component.

In a particular embodiment, the imaging preparation composition or resin composition comprises:
(i) a secondary electron generator comprising a compound having an effective atomic number (Z_{eff}) greater than or equal to 30 and a density greater than or equal to 2.5 g/cm³; and
(ii) a resin component having a density less than or equal to 2 g/cm³.

In a particular embodiment, the imaging preparation composition or resin composition comprises:
(i) a self-healing component having an effective atomic number (z_{eff}) less than or equal to 15 (optionally where z_{eff} excludes any solvates having a boiling point less than or equal to 150° C. at 100 kPa pressure) and a density less than or equal to 1.5 g/cm³; and
(ii) a resin component having a density less than or equal to 2 g/cm³.

In a particular embodiment, the resin composition comprises:
1-10 pbw secondary electron generator comprising a compound having an effective atomic number (Z_{eff}) greater than or equal to 30 and a density greater than or equal to 2.5 g/cm³; and
(ii) 70-98 pbw base component having a density less than or equal to 2 g/cm³.

In a particular embodiment, the resin composition comprises:
1-10 pbw self-healing component having an effective atomic number (z_{eff}) less than or equal to 15 (optionally where z_{eff} excludes any solvates having a boiling point less than or equal to 150° C. at 100 kPa pressure) and a density less than or equal to 1.5 g/cm³; and
(ii) 70-98 pbw resin component having a density less than or equal to 2 g/cm³.

In a particular embodiment, the resin composition comprises:

a resin component (suitably a synthetic resin, a hardener, and optionally an accelerator);

a secondary electron generator comprising a metal compound (suitably a metal halide or complex thereof), wherein the metal compound has a density between 3.5 and 8.3 g/cm³, and comprises a metal species which has an atomic number (Z) greater than or equal to 57; and

a self-healing component (suitably di pentaerythriolpentaacrylate (DPEPA) or pentaerythritoltetraacrylate (PET)).

In a particular embodiment, the resin composition comprises:

a resin component (suitably a synthetic resin, a hardener, and optionally an accelerator);

a self-healing component having an effective atomic number (z_{eff}) less than or equal to 15 (optionally where z_{eff} excludes any solvates having a boiling point less than or equal to 150° C. at 100 kPa pressure) and a density less than or equal to 1.5 g/cm³; and

optionally a secondary electron generator, suitably comprising a metal compound (suitably a metal halide or complex thereof), wherein the metal compound has a density between 3.5 and 8.3 g/cm³, and comprises a metal species which has an atomic number (Z) greater than or equal to 57; and

In a particular embodiment, the resin composition comprises:
(i) a resin component (suitably a synthetic resin, a hardener, and optionally an accelerator); and
(ii) a self-healing component having an effective atomic number (z_{eff}) less than or equal to 15 (optionally where z_{eff} excludes any solvates having a boiling point less than or equal to 150° C. at 100 kPa pressure) and a density less than or equal to 1.5 g/cm³; and
(iii) optionally a secondary electron generator, suitably comprising a compound having an effective atomic number (z_{eff}) greater than or equal to 25 and a density greater than or equal to 2 g/cm³; and
   wherein the secondary electron generator has a higher density than the resin component and the self-healing component;
   wherein the secondary electron generator has a higher Z_{eff} than the resin component and the self-healing component;
(suitably where Z_{eff} excludes any solvates having a boiling point less than or equal to 150° C. at 100 kPa pressure).

In a particular embodiment, the resin composition comprises:
(i) a resin component (suitably a synthetic resin, a hardener, and optionally an accelerator); and
(ii) a secondary electron generator comprising a compound having an effective atomic number (Z_{eff}) greater than or equal to 25 and a density greater than or equal to 2 g/cm³; and
(iii) a self-healing component (suitably dipentaerythriolpentaacrylate (DPEPA) or pentaerythritoltetraacrylate (PET));
   wherein the secondary electron generator has a higher density than the resin component;
   wherein the secondary electron generator has a higher Z_{eff} than the resin component;
(suitably where Z_{eff} excludes any solvates having a boiling point less than or equal to 150° C. at 100 kPa pressure).

In a particular embodiment, the resin composition comprises:
(i) a resin component having a density less than or equal to 2 g/cm³; and
(ii) a secondary electron generator comprising a compound having an effective atomic number (Z_{eff}) greater than or equal to 30 and a density greater than or equal to 2.5 g/cm³; and
(iii) optionally a self-healing component (suitably dipentaerythriolpentaacrylate (DPEPA) or pentaerythritoltetraacrylate (PET));
   wherein the secondary electron generator has a higher Z_{eff} than the resin component;
(optionally where either or both density and/or Z_{eff} excludes any solvates having a boiling point less than or equal to 150° C. at 100 kPa pressure).

In a particular embodiment, the resin composition comprises:
(i) a resin component having a density less than or equal to 2 g/cm³; and
(ii) a self-healing component having an effective atomic number (z_{eff}) less than or equal to 15 (optionally where z_{eff} excludes any solvates having a boiling point less than or equal to 150° C. at 100 kPa pressure) and a density less than or equal to 1.5 g/cm³; and
(iii) optionally a secondary electron generator comprising a compound having an effective atomic number (Z_{eff}) greater than or equal to 30 and a density greater than or equal to 2.5 g/cm³;
   wherein the secondary electron generator has a higher Z_{eff} than the resin component and the self-healing component;
(optionally where either or both density and/or Z_{eff} excludes any solvates having a boiling point less than or equal to 150° C. at 100 kPa pressure).

In a particular embodiment, the resin composition comprises:
(i) a resin component having an effective atomic number (Z_{eff}) less than or equal to 15 and having a density less than or equal to 2 g/cm³; and
(ii) a secondary electron generator comprising a compound having an effective atomic number (Z_{eff}) greater than or equal to 30 and a density greater than or equal to 2.5 g/cm³; and
(iii) optionally a self-healing component (suitably dipentaerythriolpentaacrylate (DPEPA) or pentaerythritoltetraacrylate (PET));
(optionally where either or both density and/or Z_{eff} excludes any solvates having a boiling point less than or equal to 150° C. at 100 kPa pressure).

In a particular embodiment, the resin composition comprises:
(i) a resin component having an effective atomic number (Z_{eff}) less than or equal to 15 and having a density less than or equal to 2 g/cm³; and
(ii) a self-healing component having an effective atomic number (Z_{eff}) less than or equal to 15 (optionally where z_{eff} excludes any solvates having a boiling point less than or equal to 150° C. at 100 kPa pressure) and a density less than or equal to 1.5 g/cm³; and
(iii) optionally a secondary electron generator comprising a compound having an effective atomic number (Z_{eff}) greater than or equal to 30 and a density greater than or equal to 2.5 g/cm³;
(optionally where either or both density and/or Z_{eff} excludes any solvates having a boiling point less than or equal to 150° C. at 100 kPa pressure).

In a particular embodiment, the resin composition comprises:
(i) a resin component having an effective atomic number (Z_{eff}) less than or equal to 15 and having a density less than or equal to 2 g/cm³; and
(ii) a secondary electron generator comprising a compound having an effective atomic number (Z_{eff}) greater than or equal to 30 and a density greater than or equal to 2.5 g/cm³; and
(iii) optionally a self-healing component (suitably dipentaerythriolpentaacrylate (DPEPA) or pentaerythritoltetraacrylate (PET));
   wherein the compound(s) of the secondary electron generator has a mean ionization potential of greater than or equal to 200 eV;
   wherein the compound(s) of the secondary electron generator has a lower mean free path (λ) than the resin component;
   wherein the compound(s) of the secondary electron generator has a higher scattering cross-section (σ) than the resin component;
(optionally where any, some or all of density, Z_{eff}, mean ionization potential, mean free path (λ), and/or scattering cross-section (σ) excludes any solvates having a boiling point less than or equal to 150° C. at 100 kPa pressure).

In a particular embodiment, the resin composition comprises:
(i) a resin component comprising an epoxy resin, a hardener, and optionally an accelerator (suitably 2-((4-(tert-butyl)phenoxy)methyl)oxirane, dodecenylsuccinic anhydride, N,N-dimethylbenzylamine respectively);
(ii) a secondary electron generator comprising a metal compound having an effective atomic number (Z_{eff}) greater than or equal to 40 and a density greater than or equal to 2 g/cm³; and
(iii) optionally a self-healing component (suitably dipentaerythriolpentaacrylate (DPEPA) or pentaerythritoltetraacrylate (PET));
(optionally where either or both density and/or Z_{eff} excludes any solvates having a boiling point less than or equal to 150° C. at 100 kPa pressure).

In a particular embodiment, the resin composition comprises:
(i) a resin component comprising an epoxy resin, a hardener, and optionally an accelerator (suitably 2-((4-(tert-butyl)phenoxy)methyl)oxirane, dodecenylsuccinic anhydride, N,N-dimethylbenzylamine respectively);
(ii) a self-healing component having an effective atomic number (z_{eff}) less than or equal to 15 (optionally where z_{eff} excludes any solvates having a boiling point less than or equal to 150° C. at 100 kPa pressure) and a density less than or equal to 1.5 g/cm³; and
(iii) optionally a secondary electron generator comprising a metal compound having an effective atomic number (Z_{eff}) greater than or equal to 40 and a density greater than or equal to 2 g/cm³; and
(optionally where either or both density and/or Z_{eff} excludes any solvates having a boiling point less than or equal to 150° C. at 100 kPa pressure).

In a particular embodiment, the resin composition comprises:
(i) a resin component comprising an epoxy resin, a hardener, and optionally an accelerator (suitably 2-((4-(tert-butyl)phenoxy)methyl)oxirane, dodecenylsuccinic anhydride, N,N-dimethylbenzylamine respectively);
(ii) a secondary electron generator comprising a metal compound having an effective atomic number (Z_{eff}) greater than or equal to 40, a density greater than or equal to 2 g/cm³, and comprising a metal species having an atomic number (Z) greater than or equal to 21; and
(iii) optionally a self-healing component (suitably dipentaerythriolpentaacrylate (DPEPA) or pentaerythritoltetraacrylate (PET));
(optionally where either or both density and/or Z_{eff} excludes any solvates having a boiling point less than or equal to 150° C. at 100 kPa pressure).

In a particular embodiment, the resin composition comprises:
(i) a resin component comprising an epoxy resin, a hardener, and optionally an accelerator (suitably 2-((4-(tert-butyl)phenoxy)methyl)oxirane, dodecenylsuccinic anhydride, N,N-dimethylbenzylamine respectively);
(ii) a self-healing component having an effective atomic number (z_{eff}) less than or equal to 15 (optionally where z_{eff} excludes any solvates having a boiling point less than or equal to 150° C. at 100 kPa pressure) and a density less than or equal to 1.5 g/cm³; and
(iii) optionally a secondary electron generator comprising a metal compound having an effective atomic number (z_{eff}) greater than or equal to 40, a density greater than or equal to 2 g/cm³, and comprising a metal species having an atomic number (Z) greater than or equal to 21;
(optionally where either or both density and/or Z_{eff} excludes any solvates having a boiling point less than or equal to 150° C. at 100 kPa pressure).

In a particular embodiment, the resin composition comprises:
(i) 70-98 pbw resin component comprising an epoxy resin, a hardener, and optionally an accelerator (suitably 2-((4-(tert-butyl)phenoxy)methyl)oxirane, dodecenylsuccinic anhydride, N,N-dimethylbenzylamine respectively);
(ii) 1-20 pbw self-healing component having an effective atomic number (z_{eff}) less than or equal to 15 (optionally where z_{eff} excludes any solvates having a boiling point less than or equal to 150° C. at 100 kPa pressure) and a density less than or equal to 1.5 g/cm³; and
(iii) optionally 1-10 pbw secondary electron generator comprising a metal compound having an effective atomic number (Z_{eff}) greater than or equal to 40, a density greater than or equal to 2 g/cm³, and comprising a metal species having an atomic number (Z) greater than or equal to 39 but less than or equal to 82;
(optionally where either or both density and/or Z_{eff} excludes any solvates having a boiling point less than or equal to 150° C. at 100 kPa pressure).

In a particular embodiment, the resin composition comprises:
(i) 70-98 pbw resin component comprising an epoxy resin, a hardener, and optionally an accelerator (suitably 2-((4-(tert-butyl)phenoxy)methyl)oxirane, dodecenylsuccinic anhydride, N,N-dimethylbenzylamine respectively);
(ii) 1-10 pbw secondary electron generator comprising a metal compound having an effective atomic number (Z_{eff}) greater than or equal to 40, a density greater than or equal to 2 g/cm³, and comprising a metal species having an atomic number (Z) greater than or equal to 39 but less than or equal to 82; and
(iii) optionally 1-20 pbw self-healing component (suitably dipentaerythriolpentaacrylate (DPEPA) or pentaerythritoltetraacrylate (PET));
(optionally where either or both density and/or Z_{eff} excludes any solvates having a boiling point less than or equal to 150° C. at 100 kPa pressure).

In a particular embodiment, the resin composition comprises:
(i) a resin component comprising an epoxy resin, a hardener, and optionally an accelerator (suitably 2-((4-(tert-butyl)phenoxy)methyl)oxirane, dodecenylsuccinic anhydride, N,N-dimethylbenzylamine respectively); and
(ii) a compound selected from the group including AlCl₃, TiCl₃, TiCl₄, CrCl₃, GaCl₃, YCl₃, MoCl₃, AgCl, InCl₃, SbCl₃ HfCl₃ TaCl₃, WCl₃, OsCl₃, IrCl₃, AuCl, AuCl₃, HAuCl₄, NaAuCl₄, HgCl₂, CeCl₃, NdCl₃ ErCl₃, or any suitable complex (including any suitable salt or salt complex) thereof; and
(iii) optionally a self-healing component (suitably dipentaerythriolpentaacrylate (DPEPA) or pentaerythritoltetraacrylate (PET)).

In a particular embodiment, the resin composition comprises:
(i) resin component comprising 2-((4-(tert-butyl)phenoxy)methyl)oxirane, dodecenylsuccinic anhydride, and optionally also N,N-dimethylbenzylamine respectively; and
(ii) a secondary electron generator compound selected from the group including SbCl₃ HfCl₃ TaCl₃, WCl₃, OsCl₃, IrCl₃, AuCl, AuCl₃, HAuCl₄, NaAuCl₄, HgCl₂, CeCl₃, NdCl₃ ErCl₃, or any suitable complex (including any suitable salt or salt complex) thereof; and
(iii) a self-healing component (suitably dipentaerythriolpentaacrylate (DPEPA) or pentaerythritoltetraacrylate (PET)).

In a particular embodiment, the resin composition comprises:
(i) 70-98 pbw resin component comprising 2-((4-(tert-butyl)phenoxy)methyl)oxirane, dodecenylsuccinic anhydride, and optionally also N,N-dimethylbenzylamine respectively; and
(ii) 1-10 pbw secondary electron generator compound selected from the group including SbCl₃ HfCl₃ TaCl₃, WCl₃, OsCl₃, IrCl₃, AuCl, AuCl₃, HAuCl₄, NaAuCl₄, HgCl₂, CeCl₃, NdCl₃ ErCl₃, or any suitable complex (including any suitable salt or salt complex) thereof; and
(iii) optionally 1-10 pbw self-healing component (suitably dipentaerythriolpentaacrylate (DPEPA) or pentaerythritoltetraacrylate (PET)).

The definitions relating to any of the aforesaid parameters (e.g. Z_{eff}, density, mean free path, scattering cross-sectioning, mean ionization potential/stopping power) may suitably relate to a form of the compound(s) which excludes any solvates having a bp 150° C. at 100 kPa pressure, suitably 120° C., suitably 105° C., e.g. excluding hydrates.

### EXAMPLES

### Materials and Equipment

Osmium tetroxide (OsO₄) was obtained from Sigma Aldrich, and utilized as a contrast agent.

Sodium tetrachloroaurate (NaAuCl₄) was obtained from Sigma Aldrich. Sodium tetrachloroaurate was used as a secondary electron generator in model studies for the following two reasons: 1) Gold's electron orbital cloud is dense and so upon inspection the difficultly in verifying the nanostructures is dramatically decreased; and 2) The oxidation state is stable and should not change during processing. However, it will be understood by those skilled in the art, especially in view of the predictive models outlined herein, that this particular secondary electron generator is illustrative of a generally applicable principle, and it is well within the skilled person's capability to judiciously modify the resin compositions disclosed herein to afford a whole range of resin compositions according to the invention.

Araldite CY212 and DDSA were purchased from Agar Scientific and tert-butyl methyl ether was purchased form Acros Organics. All other reagents were purchased from Sigma Aldrich and used as supplied.

Pentaerythritol tetraacrylate was obtained from Sigma Aldrich. Pentaerythritol tetraacrylate was used as a crosslinker in negative tone resin compositions.

Solvents, such as acetone, anisole, and 2-propanol were all commercially sourced and used as supplied.

A FEI Sirion Scanning Electron Microscope (SEM) was used to provide a source of an electron beam.

Gatan 3view2 combines an ultramicrotome with a field emission gun scanning electron microscope (FEGSEM). A Gatan 3View® system (specifically a 3View 2 system), which combines an ultramicrotome with a field emission gun scanning electron microscope (FEGSEM), was used in the imaging experiments performed herein. The Gatan 3View® Serial employs either focus ion beam imaging or traditional serial section imaging

The ultramicrotome employs a diamond knife which sequentially cuts a sample into thin sections, imaging each section at a time so that a 3D picture of the sample is established.

Before imaging, biological tissue samples are first stained (e.g. with OsO₄) before being “fixed” in a polymer such as araldite or poly(methyl methacrylate) (PMMA), either of which may be doped as defined herein. The “fixed” sample can then be sliced into sections as thin as 15 nm so that the images do not degrade with depth.⁵

### Example Section A

### Example A1

### Preparing a Control Resin Composition

A control resin composition (without any secondary electron generators) was prepared by mixing araldite M (2.3 g, 11.1 mmol), BDMA (0.12 g, 0.888 mmol), DDSA (2.2 g, 8.26 mmol) and acetone (0.1 g, 1.72 mmol).

TABLE 1
The chemical structure of Araldite M, Dodecenylsuccinic anhydride and
N,N-dimethylbenzylamine.

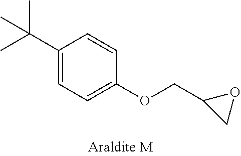

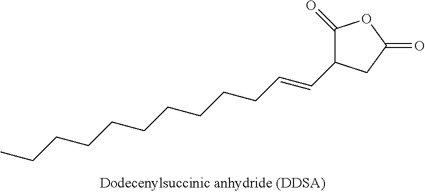 [SMILES: CCCCCCCCCC/C=C/C1CC(=O)OC1=O]

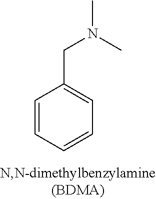

### Example A2

### Preparing a Doped Resin Composition

A doped resin composition was prepared in an identical manner to the control of Example A1, except that sodium tetrachloroaurate (NaAuCl₄.2H₂O) (in a ratio of 0.0087% NaAuCl₄.2H₂O to araldite) was additional added to this doped composition.

### Example A3

### Preparing Biological Sample(s)

Rat kidney cells, were prepared for SEM imaging in both araldite and sodium tetrachloroaurate doped araldite. Two solutions of araldite (2.3 g, 11.1 mmol), BDMA (0.12 g, 0.888 mmol), DDSA (2.2 g, 8.26 mmol) and acetone (0.1 g, 1.72 mmol) were prepared; 0.0087% NaAuCl₄.2H₂O (0.05 g, 0.126 mmol) was added to one. The rat kidney cells were stained with Osmium tetraoxide (OsO₄) to provide an adequate level of contrast for detection. The stained cells were then placed into the two solutions and baked overnight in an oven at 80° C. to harden before being removed and allowed to cool to room temperature. The samples were then cut into thin sections at four different thicknesses; 250 nm, 500 nm, 750 nm and 1000 nm, using a ultracut microtome before being mounted onto two 500 μm silicon substrates as the silicon is perfectly flat and the metal behind is not imaged. Protocols for biological sample preparation for imaging with an ultramicrotome may be readily varied by those skilled in the art.

### Example A4

### Monte Carlo Simulation

The Monte Carlo simulation presented is based on the model developed by Joy^{[7]}. The two systems were first modeled by Monte Carlo Simulations to determine if the sodium tetrachloroaurate doped system is able to increase the number of secondary electrons compared to the araldite system, and hence improve the resolution in scanning electron microscopy of cellular samples. The samples were modeled at four different thicknesses: 250 nm, 500 nm, 750 nm and 1000 nm, each one on 1000 nm of silicon. The physical properties of the components used in the simulations are given in Table 2.

TABLE 2
Physical properties of the materials
used in the Monte Carlo models.⁷

| | Araldite | | |
|---|---|---|---|
| Physical property | M | NaAuCl4•2H₂O• | Silicon |
| Density (g/cm³) | 1.038 | 0.8 | 2.33 |
| Effective atomic number | 5.521 | 42.9757 | 14 |
| Effective atomic weight | 206.283 | 397.7854 | 28.0855 |
| (g/mol) | | | |
| Mean ionization potential | 95.76 | 448.0743 | 174 |
| (eV) | | | |

For the simulations; the incident electron beam used had a Gaussian distribution with a spot size of 3 nm, the number of electrons used in the models was 100000, and the simulations were run only once.

### Results and Discussion A

### Monte Carlo Simulations

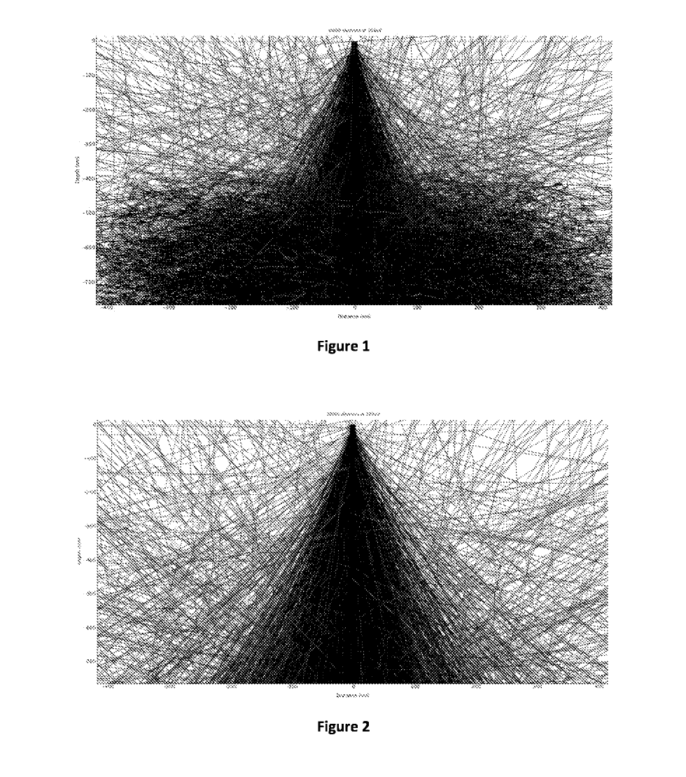

FIGS. 1 and 2 show the scattering trajectories of the incident electron beam in the two different systems at a beam energy of 10 keV. As can be seen, the electrons diverge away from the incident beam due to interactions with the araldite and NaAuCl₄ molecules, with the black lines showing the paths taken by the incident electrons, the red lines showing the paths taken by the secondary electrons and the blue lines showing the paths taken by the back scattered electrons. The scattering plots look very different for the araldite system and the sodium tetrachloroaurate doped araldite systems. For the araldite system there is a thickness threshold of 400 nm after this point the damage caused by the beam broadens. This does not occur in the NaAuCl₄ doped araldite system as the NaAuCl₄ confines the beam to its immediate area. This difference in the scattering plots is believed to be due to the difference in density of araldite (1.038 g/mol) and NaAuCl₄ (0.8 g/mol). The density of NaAuCl₄ doped araldite system is lower so more primary electrons are believed to pass through the sample without colliding, whereas for the araldite system there is a higher density of molecules so the incident beam collides with more molecules resulting in a higher electron density within the sample. The sodium tetrachloroaurate doped system produces more secondary electrons (red lines in the scattering plots) than the araldite system. This is thought to be due to the difference in their effective atomic numbers (Table 2) of the two systems. The effective atomic number is much higher for the sodium tetrachloroaurate doped araldite system; there are more electrons in the system with which the primary electrons can collide to produce secondary electrons.

FIG. 1 shows a graphical representation of scattering trajectories of the araldite system (750 nm) at am electron beam energy of 10 keV, number of electrons 10000.

FIG. 2 shows a graphical representation of scattering trajectories of the sodium tetrachloroaurate doped araldite system (750 nm) at a beam energy of 10 keV, number of electrons 10000.

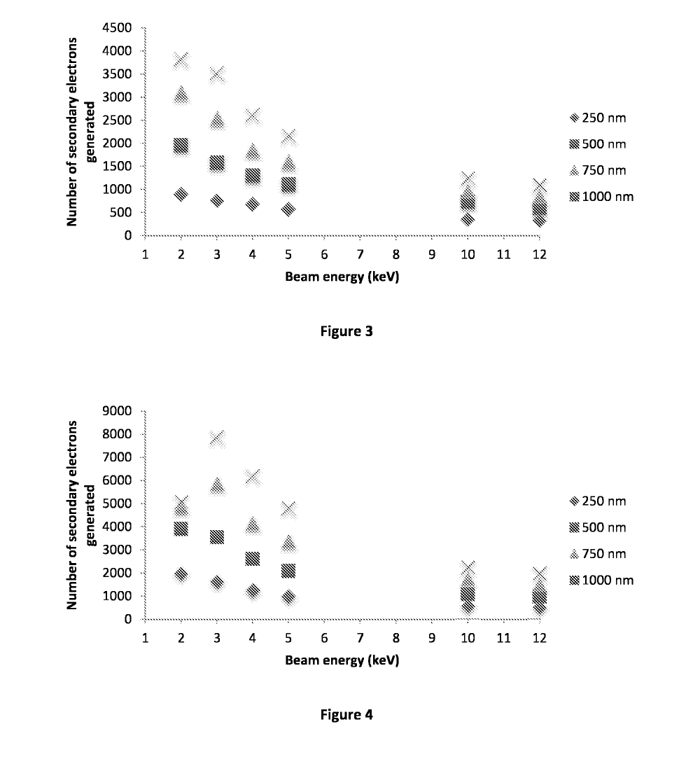

The number of secondary electrons produced by the two systems is shown in FIGS. 3 and 4. As can be seen, as the beam energy increases the number of secondary electrons decreases. This is because the incident electrons have more energy at higher keV, and so penetrate further into the sample before colliding with the araldite and NaAuCl₄ molecules to produce secondary electrons. As these secondary electrons are produced further into the sample, not all of them are detected by the detector, which lies directly above the sample and sees only the electrons that exit the top surface of the sample. From the model it can be seen that 2 keV appears to be the optimum beam energy to use for the araldite system with 3 keV being the optimum beam energy for the sodium tetrachloroaurate doped araldite system. The number of secondary electrons produced also depends upon the thickness of the sample. As the thickness increases the number of secondary electrons produced also increases, this is due to the incident electrons colliding with more sample molecules producing more secondary electrons. Therefore the increase in the number of secondary electrons produced is dependent upon on the thickness of the sample and the beam energy at which it is sampled.

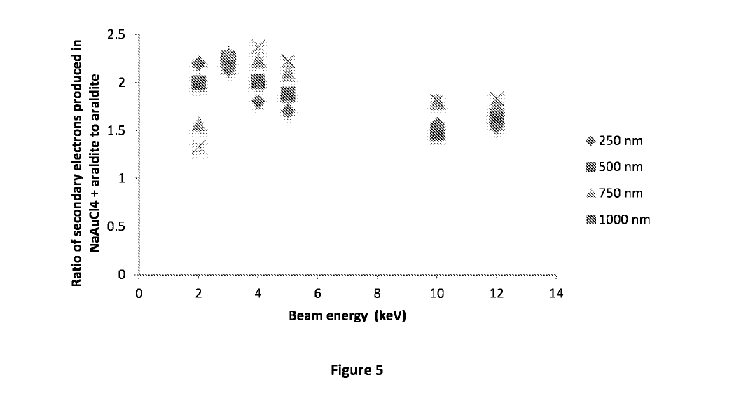

FIG. 5 shows the ratio of the number of electrons produced in the sodium tetrachloroaurate doped system compared to the araldite system. It can be seen that the model predicts that the NaAuCl₄ system will produce more secondary electrons than the araldite system, between 1.3-2.4 times depending upon the thickness of the sample and the beam energy used. The sodium tetrachloroaurate system generates more secondary electrons than the araldite system due to the increase in the effective atomic number. As the effective atomic number is larger for the NaAuCl₄ system, there are more electrons in the molecules, so more secondary electrons can be generated.

There appears to be a statistical error in the data at 2 keV; at this beam energy the data does not follow the same trend as for the other beam energies. Had the model been run more than once it would have been averaged to avoid this statistical error from occurring.

FIG. 3 is a graph showing secondary electron production in the araldite system system for different beam energies and sample thickness.

FIG. 4 is a graph showing secondary electron production in the araldite+sodium tetrachloroaurate system system for different beam energies and sample thickness.

FIG. 5 represents a combination of the data of FIGS. 3 and 4, and shows the ratio of secondary electron production of the sodium tetrachloroaurate doped araldite system to the araldite system.

### SEM Imaging

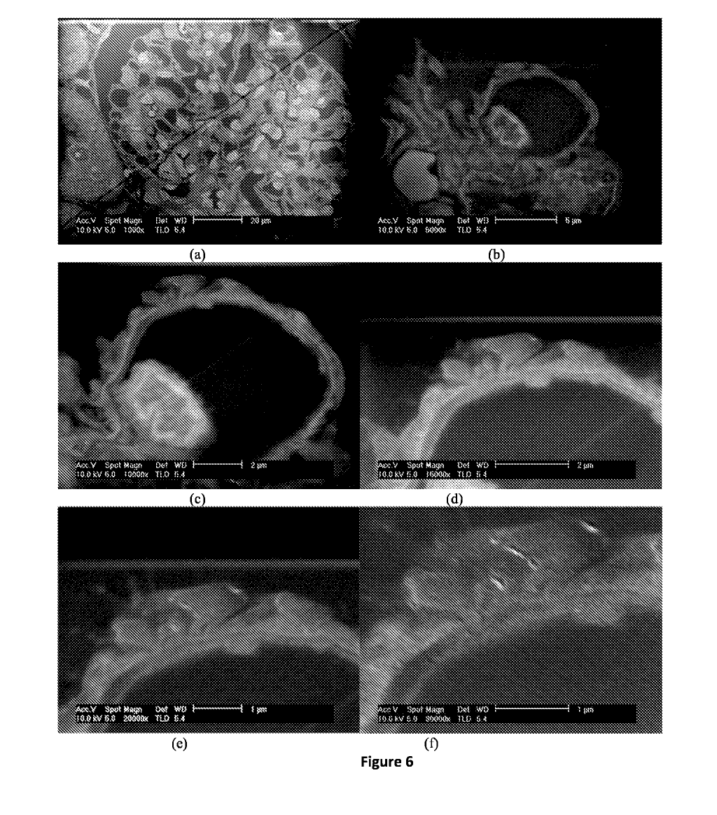

The samples were imaged by an FEI Sirion scanning electron microscope, to experimentally determine which material system provides an increase in resolution for cellular samples in SEM. The sample thickness chosen for each system was 750 nm and the beam energy used was 10 keV. This allows us to achieve the maximum resolution whilst obtaining a relatively good contrast. FIG. 6 below shows the images collected from the rat kidney sample in araldite.

FIG. 6 shows a SEM image of a rat kidney, stained with Osmium tetraoxide, in an araldite-only resin composition, with a thickness of 750 nm. At magnification; (a) mag ×1000, (b) mag ×5000, (c) mag ×10000, (d) mag ×15000, (e) mag ×20000 and (f) mag ×30000.

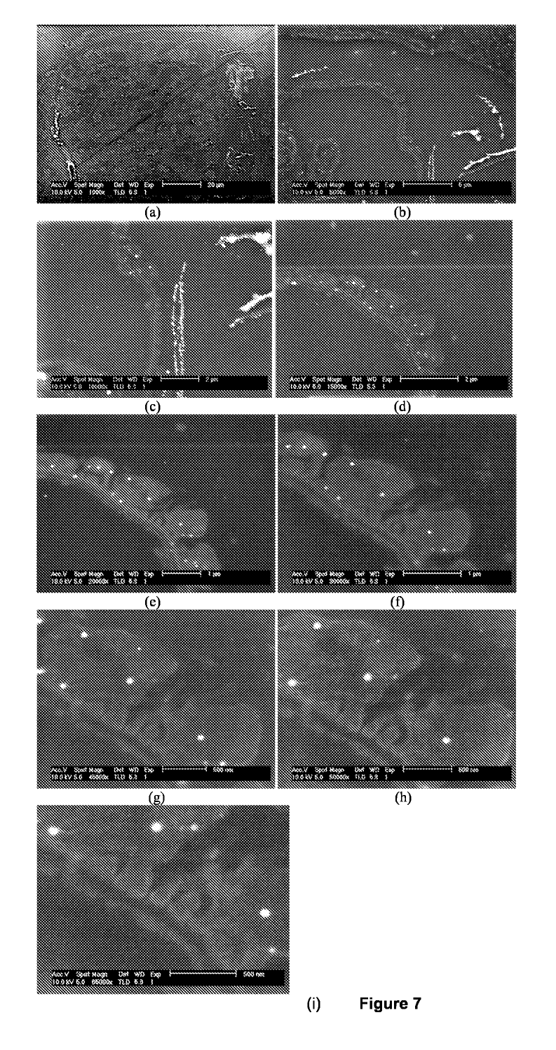

FIG. 7 shows images comparable to those of FIG. 6, except this time encapsulated in an araldite system doped with sodium tetrachloroaurate. The SEM image of a rat kidney was again stained with Osmium tetraoxide, cut to a thickness of 750 nm, and is shown at a magnification of (a) mag ×1000, (b) mag ×5000, (c) mag ×10000, (d) mag ×15000, (e) mag ×20000 and (f) mag ×30000, (g) mag ×45000, (h) mag ×50000, (i) mag ×65000.

The cell samples in araldite were imaged up to 30000 times magnification, at this magnification the images were starting to become blurry and unclear. The contrast was not good enough after this point to clearly make out the structural detail. However the cell samples in the sodium tetrachloroaurate doped araldite were imaged up to 65000 times magnification, at this point the image obtained was of a similar resolution as the image obtained in araldite at the lower magnification of 30000 times magnification. This is 2.2 times the magnification that was achievable with the araldite system. The monte carlo simulation predicted that the sodium tetrachloroaurate doped araldite would produce 1.8 times the number of secondary electrons than araldite, this theoretical result is confirmed by the experimental result of the cell images being obtained at twice the magnification.

In the sodium tetrachoroaurate doped araldite images there are bright spots, these correspond to the gold compound clumping in the cell due to the acetone evaporating before the solvent of the araldite. This clumping is beneficial as it helps with the focusing of the SEM machine in order to gain clear images, however ideally the gold should not clump but should be uniformly distributed throughout the sample.

### Electron Beam Stability

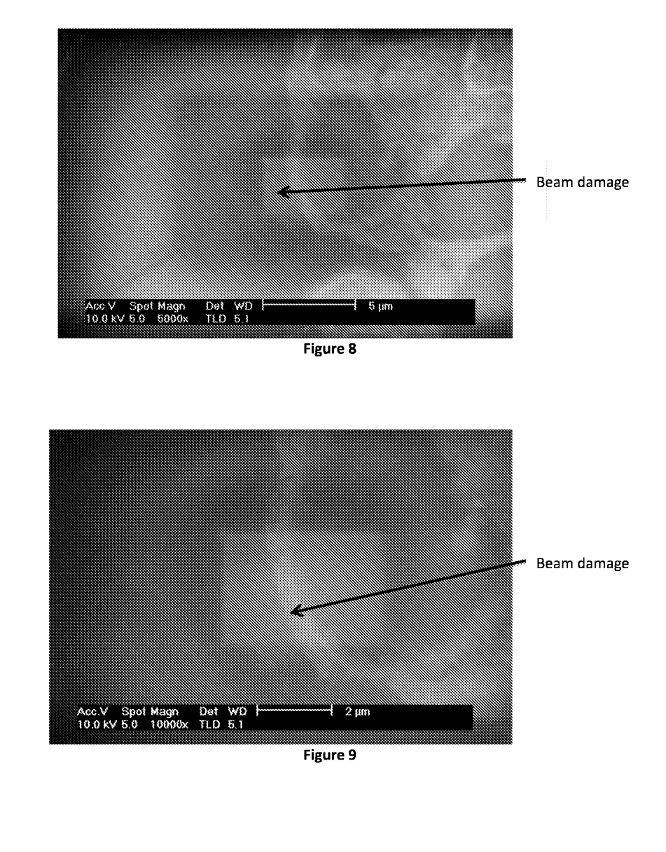

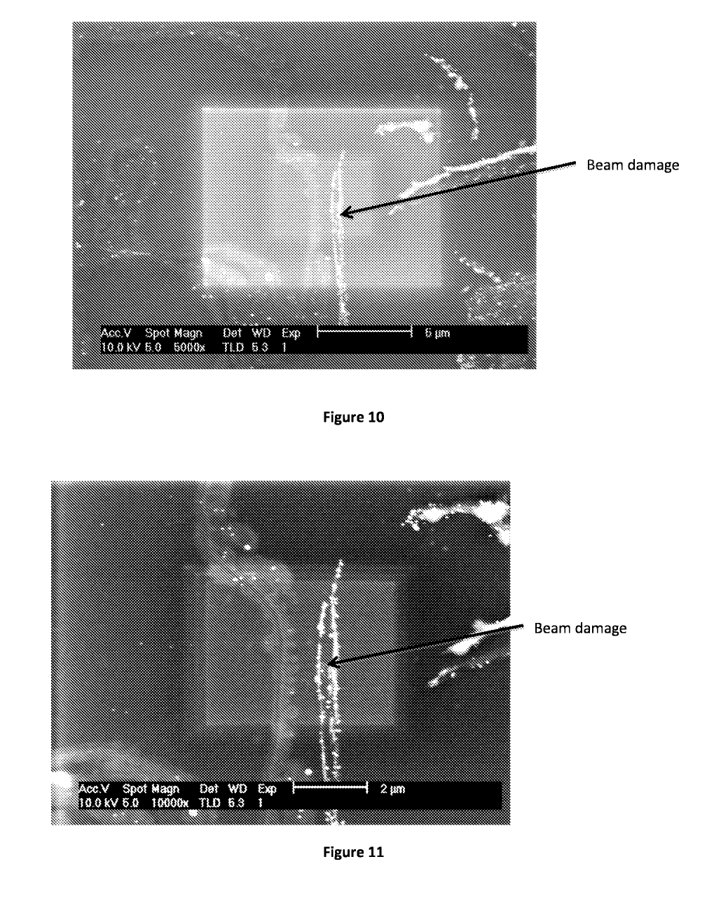

The electron beam causes beam damage to the samples as the incident electrons have enough energy to break the bonds within the araldite. Normally the beam damage results in damage of the cell samples and the images becoming less clear with increasing time of exposure to the electron beam before becoming too damaged to be imaged. After beam damage has occurred this area of the cell is unable to be imaged. However, this is not found to be the case for the two systems. Instead it was found that the region of the cell sample within the beam damage appears brighter (FIGS. 8 and 10) and that clear images can be obtained within this area even after beam damage has occurred (FIGS. 9 and 11). This is because the araldite is breaking down around the cell sample producing more scattering centres for secondary electron generation and leaving the sample more exposed to the incident electron beam. Therefore, more secondary electrons are being produced, so the intensity detected is greater making this region of the cell appear white and much brighter than before. The sodium tetrachloroaurate doped araldite system yields brighter, clearer images after beam damage than the araldite system. This is because the NaAuCl₄ molecules attract the secondary electrons that are produced, localizing them, this reduces the beam damage caused to the sample, therefore in this system the quality of the images recorded after beam damage is greater than those recorded in the araldite system.

FIG. 8 shows an SEM image of a rat kidney stained with Osmium tetraoxide, encapsulated in araldite, with a sample thickness of 750 nm (mag ×5000).

FIG. 9 shows an SEM image of a rat kidney stained with Osmium tetraoxide, encapsulated in araldite, with a sample thickness of 750 nm (mag ×10000).

FIG. 10 shows an SEM image of a rat kidney showing the beam damage. The rat kidney has been stained with Osmium tetraoxide, is encapsulated in araldite doped with NaAuCl₄, with a sample thickness of 750 nm (mag ×5000).

FIG. 11 shows an SEM image of a rat kidney showing that despite the beam damage an image is acquired with a brighter contrast. The rat kidney has been stained with Osmium tetraoxide, is encapsulated in araldite doped with NaAuCl₄, with a sample thickness of 750 nm (mag ×10000).

### Conclusions to Section A

In conclusion, the Monte Carlo simulations predict that the sodium tetrachloroaurate-doped araldite would improve the contrast and beam damage compared to the araldite system as it will produce 1.8 times the number of secondary electrons in a 750 nm sample at 10 keV. This theoretical model is supported by the experimental results; which show that cell samples in NaAuCl₄ doped araldite can be imaged up to 2.2 times the magnification that they can in araldite at a thickness of 750 nm at a beam energy of 10 keV. Also the samples in sodium tetrachloroaurate doped araldite can be imaged even after beam damage has occurred and indeed beam damage appears to improve the contrast of the samples. Therefore, the sodium tetrachloroaurate doped araldite system is superior to the araldite system. Evidently, the validated Monte Carlo model enables the benefits of the present invention to be extrapolated to varying degrees to a range of systems, including a range of resins and secondary electron generators.

### Example Section B

### Example B1

### Preparation of Various Resin Compositions

Various imagable specimen samples were prepared using araldite, dodecenylsuccinic anhydride (DDSA), N,N-dimethylbenzylamine (BDMA) and acetone as per Example A1. The resin compositions of this section are identical to those of Example A1 except that they additionally include Pentraerythritol tetraacrylate (PET) and Mercuric Chloride (HgCl₂), the molecular structures of which are illustrated in Table 3.

The resin composition was prepared using standard protocols for Araldite CY 212 embedding medium,⁸ with slight modifications.

TABLE 3
The chemical structure that are incorporated in the nanocomposite resin.

| | |
|---|---|
| 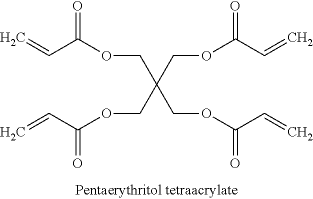 [SMILES: C=CC(=O)OCC(COC(=O)C=C)(COC(=O)C=C)COC(=O)C=C] | HgCl₂ Mercuric Chloride |

In a typical preparation, X g (please see table 4 for quantity) of PET was dissolved in the minimum quantity of tent-butyl methyl ether (typically 100-200 mg) before being added to 2.2 g DDSA and allowed to mix for 30 min. Similarly, X g (please see table 4 for quantity) of HgCl₂ was dissolved in the minimum quantity of acetone (ca. 100-200 mg), added to 2.3 g Araldite, and allowed to mix for 30 min. The DDSA and Araldite components were then added together and mixed for a minimum of 20 min to ensure complete mixing had occurred. Finally, 0.12 g BDMA was added to the Araldite/DDSA mixture and allowed to mix for 2-3 min before being aliquoted into Size 00 Beem Capsules (supplied by EM Systems Support) and cured at 60° C. for 36 h. In all cases, mixing was initiated gently by hand before being continued on a specimen rotator (Agar Scientific). Each resin mixture was prepared in triplicate. See Table 4 for component quantities in each resin.

TABLE 4
Component quantities in each resin mixture

| Resin | Araldite (g) | DDSA (g) | BDMA (g) | PET (g) ^{a} | HgCl₂ (g) ^{b} |
|---|---|---|---|---|---|
| 1 | 2.3 | 2.2 | 0.120 | — | — |
| 2 | 2.3 | 2.2 | 0.120 | 0.230 | — |
| 3 | 2.3 | 2.2 | 0.120 | 0.460 | — |
| 6 | 2.3 | 2.2 | 0.120 | 0.115 | — |
| 7 | 2.3 | 2.2 | 0.120 | 0.345 | — |
| 8 | 2.3 | 2.2 | 0.120 | 0.230 | 0.115 |
| 9 | 2.3 | 2.2 | 0.120 | 0.230 | 0.230 |
| 10 | 2.3 | 2.2 | 0.120 | 0.115 | 0.115 |
| 11 | 2.3 | 2.2 | 0.120 | — | 0.115 |

^{a} PET dissolved in 100-200 mg tert-butyl methyl ether and added to DDSA prior to mixing,
^{b} HgCl₂ dissolved in 100-200 mg acetone and added to araldite prior to mixing

Resin sections (100-250 nm) were then cut with a glass knife on a Reichert-Jung Ultracut Ultramicrotome and collected on silicon wafers.

### Example B2

### Characterization of the Araldite Based Nanocomposite Resin to Determine the Electron Beam Damage

To gain an insight to control the beam damage, electron beam lithography was utilized in order to control the amount of electrons were incident on the sample. This was done to accurately simulate a high resolution imaging conditions by exposing small areas with a known amount of the electrons per unit area. From this, the amount of beam damage can be ascertained from the exposure dose. As the electron beam will cut the resin via the chain scission process, the exposure depth can be measured using a Detak surface profilometer. Therefore, if the resin has cross linked then the depth of change will be greatly reduced when compared to the standard resin.

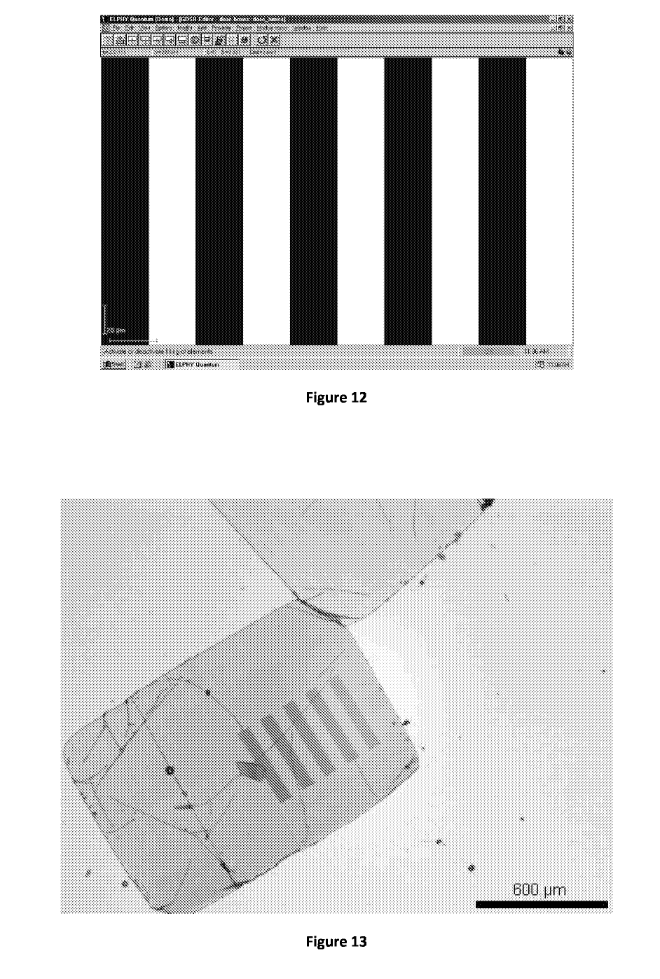

The exposure doses of resin materials were determined from a 1 dimensional matrix of 20 μm by 200 μm boxes, each box had a period of 40 μm. These were exposed with a dose scale from 1 to 5 in incremental steps of 1, and the test pattern is shown in FIG. 12. All resins were then exposed using a FEI Sirion Scanning Electron Microscope (SEM). The exposure pattern was written using acceleration voltages of 5 and 10 KeV and their probe currents were 1.55 and 2.18 nA respectively. The dwell time was 3 μS and the step size was 12.2 nm. From these exposure parameters, the base dose was calculated to be 3120 and 4388 μC/cm2. Each pattern was exposed using a write field of 200 μm.

Once the exposure pattern had been performed the depth of the exposure was measured using a Detak surface profilometer. The conditions of the measurement was that the length of the measurement was 800 μm and the force of the tip was varied from 3, 6 and 9 mg/N. This was varied to ascertain if by increasing the force of the tip would influence the depth. i.e. increasing the beam damage. This was done to simulate if the force of the diamond knife is independent of the electron beam.

### Results & Discussion B

FIG. 13 shows an optical image of a typical section on a Silicon substrate that was exposed with a 5 KeV electron beam. In particular FIG. 13 shows an optical image of a section with a thickness of 110 nm that was exposed with a 5 KeV electron beam. The section has an exposure pattern of 5 boxes, where the box on the far right had an exposure dose of 4388 μC/cm² and the box on the far left had an exposure of 21940 μC/cm². This means that the box which was exposed with 4388 μC/cm² had 549485895000 electrons exposed in the area whereas the box exposed with 21940 μC/cm² had 2747429475000 electrons exposed in the area.

From this, it can be deducted that the amount of electron collisions in the resin would be increased at the larger doses and therefore the chain scission process would be inherently increased leading to a larger depth. Hence, the colour of the boxes is getting darker from right to left. This is due to the light scattering of the interference colours with the changing thickness in that region.

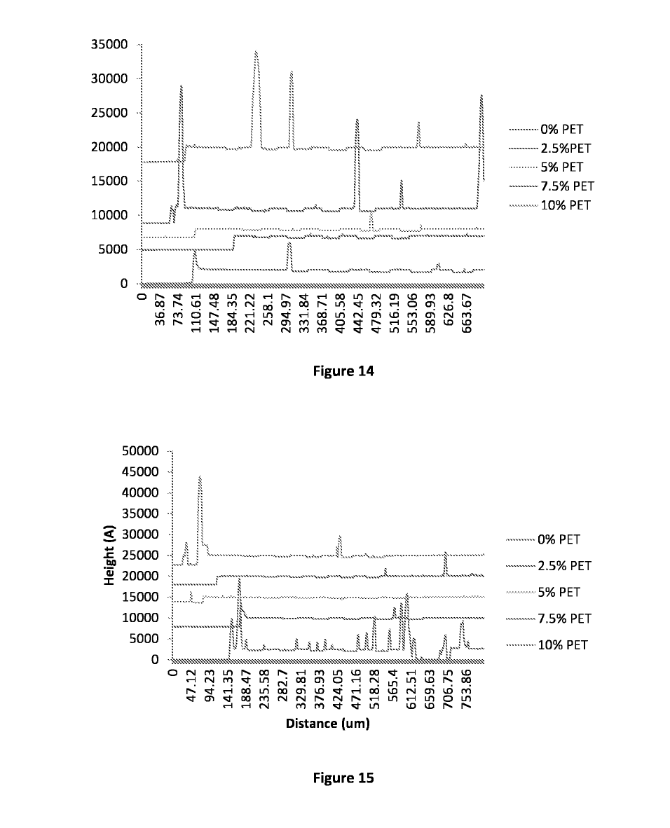

FIG. 14 shows a surface profile of each resin that was exposed to the electron beam with an acceleration voltage of 5 KeV. The spikes in the characteristic are from particles that were obtained in transit from the SEM tool to the Detak tool.

It can be seen that the depth increases with increasing exposure, which is from left to right. Hence, there are 5 times the amount of electrons in the beam. Therefore, they are 5 times more likely to collide with the electrons in the outer shell of the atoms present. This is because the mean free path between the atoms of the molecule is small and the primary electrons (PE) will experience more collisions as it travels through the resin film. A consequence of this is that the PE's lose a small amount of energy, for the case of Araldite it is 95.76 eV per collision. Upon each collision, more and more energy is lost from the incident PE's and they will slow down and come to rest. As the energy associated with the PE is greatly reduced, a secondary electron (SE) is created. These SE will experience an increased number of scattering events (due to that their associated energy is considerably lower than that of the PE) and these collisions generate even more SE. This is significant, because they are scattered at angles larger than 80° in arbitrary trajectories away from the primary beam. These electrons expose the resin laterally. This is why the SE plays a major role in causing the beam damage. It can be seen that at the energies of 10 to 5 KeV, the PE is slow enough to cause multiple inelastic scattering events and generate more and more SE. The same characteristic can also be seen in FIG. 15 for the samples that were exposed with a 10 KeV electron beam.

As the exposure that contains the most electrons was exposure number 5, then this will cause the most damage and therefore offer the worst case scenario and will be the subject of study.

FIG. 15 shows a surface depth profile of the nanocomposite resin which was exposed with a 10 KeV electron beam.

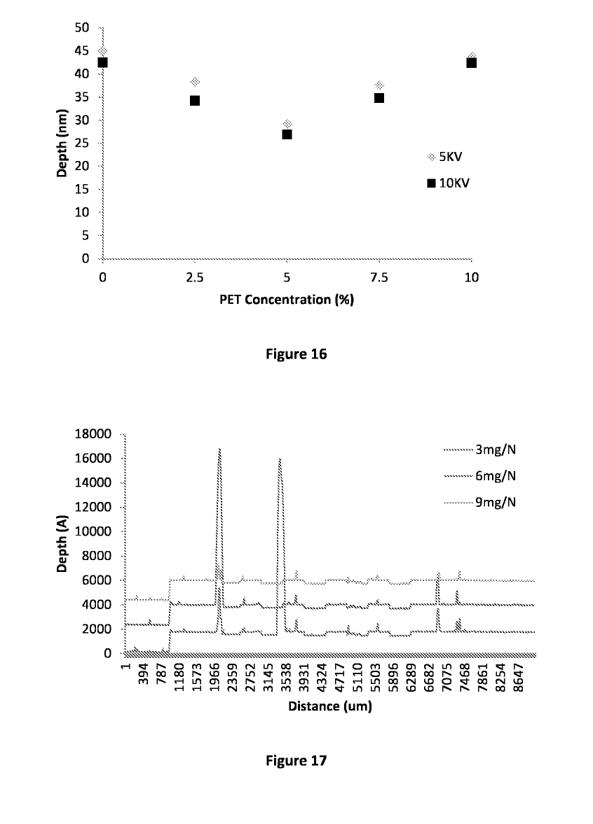

FIG. 16 shows the results that were obtained from FIGS. 14 and 15. It can be clearly be seen that the resin that contains 5% cross linker had the smallest depth change of 26 nm. This is a 1.6 times improvement when comparing it to the result of the standard Araldite resin. This means that when cutting a 50 nm section, the chances of destroying the next section that lies underneath is reduced because the beam damage seen here is well outside the section distance. Therefore, introducing the cross linker had a desirable effect. However, FIG. 16 also shows that as the cross linker increases past the optimum which was 5% cross linker the effect is less favourable, this is because the number of cross linking sites per unit area are occupied and therefore the cross linker now behaves as a secondary electron generator (which are created from the Alkene groups of the molecule) which will contribute to the chain scission process and will increase the depth in the exposure area.

FIG. 16 shows a surface depth profile of the largest exposure dose.

It is evident that there appears to be slight difference in depth based on the acceleration voltage. This is because at the energy of 10 KeV, the incident electron has more energy associated with it, and therefore, to generate a secondary electron it needs to have more collisions with the atoms in the resin material to lose most of its energy to generate a SE. However, as the film is approximately a 100 nm thick, there are not enough atoms in the film (in the z direction) to scatter off to lose a large proportion of its energy. The consequence of this is that the a substantial number of PE's will come to rest deep into the silicon substrate below or they will be back scattered into the underside of the resin material, approximately 30-40 μm away from the immediate exposure area. Hence, this why the 5 KeV data appears to have a greater depth profile than the 10 KeV characteristic and is shown in FIG. 16. Therefore as the beam damage is the same 10 KeV can be used to inspect the sample, thus a higher resolution can be obtained.

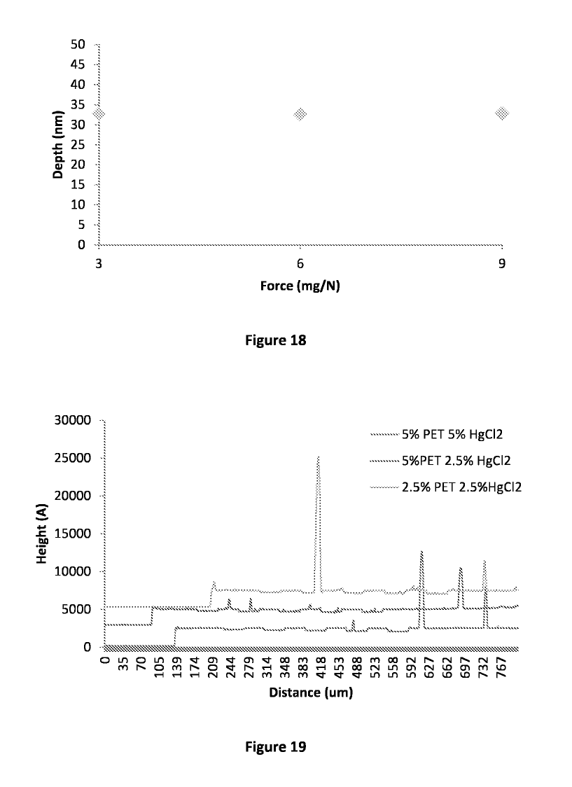

To test the effect of the force of the diamond knife makes on the resin as it cuts a section was performed by increasing the force on the tip of the Detak tool. FIG. 17 shows the depth profile of the sample that was exposed with 5 KeV electron beam. From this it can be seen that the force on the tip was increased from 3 to 9 mg/N and the effect of this is shown in FIG. 18.

FIG. 17 shows a depth profile of the nanocomposite resin which as 2.5% PET in it. This was exposed with a 5 KeV electron beam.

Taking the data from the largest exposure dose from FIG. 17 which was 21940 μC/cm², each sample gave a depth of approximately 32 nm, where it can be clearly seen that the characteristic has produced a straight line across all applied forces. Therefore, it is evident that the change in depth is negligible. Therefore based on this result, it can be ascertained that the force of the diamond knife as it cuts the nanocomposite resin will have virtually no effect. This is because the cross linker has bonded the molecules together, thus, the molecule remains intact after sectioning.

FIG. 18 shows a depth profile of the largest exposure dose. The sample is the nanocomposite resin which as 2.5% PET incorporated within it.

### Resin Optimization

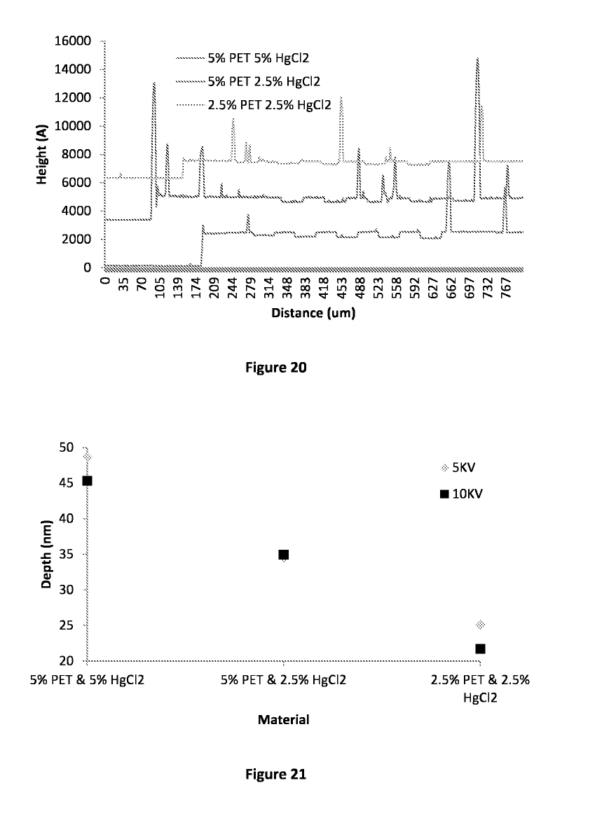

To build on these results the optimum resin formulation needed to be found, where Mercuric chloride was introduced to the Araldite/Cross linker resin. This was done in order to generate secondary electrons that will increase the statistical chance of being detected by either a back scatter detector or a secondary electron detector to produce a high resolution image. FIG. 19 shows the depth profile of the sample that was exposed with a 5 KeV beam, while FIG. 20 shows the depth profile that was exposed with a 10 KeV beam.

FIG. 19 shows a depth profile of the nanocomposite resin which incorporated PET and HgCl₂ molecules. These materials were exposed with a 5 KeV electron beam.

FIG. 20 shows a depth profile of the nanocomposite resin which incorporated PET and HgCl₂ molecules. These materials were exposed with a 10 KeV electron beam.

FIG. 21 shows the results that were obtained from FIGS. 19 and 20. The immediate observation from FIG. 21 is that as the concentration of HgCl₂ increases, the amount of beam damage increases as the depth of the exposure increases. This was because the HgCl₂ have a larger electron energy stopping power and therefore reduces the energy of the electron (623.12 eV per collision). As the energy reduction of the primary electron passes the threshold of which a secondary electron is created and will scatter at angle of larger than 80°. As they collide with the polymer and HgCl₂ atoms, their energy will be reduced. Hence, more secondary electrons will be generated and this will create an avalanche effect. As a result of the scattering angle the secondary electron penetrates through the resin it exposes it laterally. This had the effect of increasing the exposure penetration depth as more and more HgCl₂ is added into the nanocomposite resin. To decrease the amount of beam damage, the HgCl₂ concentration must be decreased to compensate for the cross linker as this generates extra concentration of electrons (generated from the presence of its Alkene groups) in the immediate exposure area.

It can be seen from FIG. 21 that the optimum resin consists of 2.5% cross linker and 2.5% HgCl₂. It was found that there was a 50% improvement when comparing it to the standard Araldite resin.

FIG. 21 shows a depth profile of the largest exposure dose, these materials had PET and HgCl₂ molecules incorporated into the resin.

It can be clearly seen that the depth created by the 5 KeV exposure was increased when compared to that of depth profiles produced by the 10 KeV exposure. This was due to that more SE's are generated at the lower energies than that of the higher energies. This was because at the larger energies the interaction between the PE and the nanocomposite resin material was greatly was reduced and the amount of collisions with the HgCl₂ material remained relatively constant. Hence, the trend of the characteristic has a decreasing gradient. From this, it is expected that the sectioning performance of these nanocomposite resin materials will be significantly reduced when compared to the standard Araldite resin.

It was found from FIG. 21 that the nanocomposite resin with 5% cross linker and 5% HgCl₂ produced a depth of 48 and 45 nm (5 KeV and 10 KeV exposure voltages) while the standard Araldite resin produced a depth of 42 nm at both acceleration voltages. Comparing these results, it was evident that it produced relatively the same beam damage this is because the excess amount of HgCl₂ is contributing to the number of cross linking sites per unit area which are occupied and thus the cross linker and HgCl₂ are now behaving as a secondary electron generators which will contribute to the chain scission process and will increase the depth in the exposure area and this can be seen FIG. 21.

### Conclusions for Section B

A metal organic nanocomposite resin that heals itself has been investigated. The self healing mechanism occurs when it is radiated by an incident electron beam. This has been achieved by introducing a cross linker called Pentraerythritol tetraacrylate (PET) and the Mercuric Chloride to the resin film improved the exposure stability of the material.

It was found that the exposure dose produced a depth in the nanocomposite resin of 21 and 25 nm (10 KeV and 5 KeV) when 2.5% of PET and 2.5% of HgCl₂ were introduced into the Araldite resin polymer matrix respectively. From these observations, it was found that the PET material acted as a cross linker as when it was radiated by the incident electron beam it generated secondary electrons (these are responsible for ‘exposing’ the resin) from its Alkene groups which in turn cross linked the resin which exhibited a 50% improvement over the standard Araldite resin.

Also, it was found the effect of incorporating the PET molecule improved the sectioning stability of the nanocomposite resin. It was ascertained that the force of the diamond knife as it cuts the nanocomposite resin will have virtually no effect as it was found that as the force of the Detak tip was increased, the measured depth was approximately 32 nm across all the forces that were applied.

Therefore, it can be ascertained that higher resolution images can be achieved with the minimum electron beam damaged as it is well known that higher acceleration voltages produce higher resolution images as if the energy of the electron is reduced, the electron beam broadens which decreases the overall resolution.

It is self-evident that the benefits of the invention can be realised across a range of systems employing various resins and self-healing components.

### REFERENCES

[1] Electron Microscope Project, http://antoine.frostburg.edu/engin/sem/workings.html, accessed March 2014)
[2] S. E. Kirk, J. N. Skepper & A. M. Donald, journal of Microscopy, 2009, 233, 205-224
[3] R S. Moolday and P. Maher, Histochemical journal, 1980, 12, 273-315
[4] R. F. Egerton, P. Li, M. Malac, Micron, 2004, 35, 399-409
[5] Gatan 3View2, http://www.gatan.com/_pvwB91795DC/files/PDF/products/BR_3View2_Brochure_FL1.pdf, (accessed March 2014)
[6]6 World News, http://article.wn.com/view/2013/10/20/Gatan_s_3View_capability_extends_high_throughput_3D_Imaging_/, (accessed March 2014)
[7] S. Lewis, L. Piccirillo, ‘Influence of nanocomposite materials for next generation nanolithography’, ‘Advances in diverse Industrial application of nanocomposites’, Intech, pp 503-528, March 2011, ISBN: 978-953-307-202-9.
[8] A. M. Glauert and R. H. Glauert, J. Biophys. Biochem. Cytol., 1958, 4, 191-194

1. A method of preparing a specimen for imaging, the method comprising:
providing a specimen; and
transforming the specimen into an imagable specimen sample;
wherein transforming the specimen into an imagable specimen sample comprises incorporating a resin composition into the specimen, wherein the resin composition comprises a resin component, and further comprises a secondary electron generator;
wherein the secondary electron generator comprises a compound having an effective atomic number (Z_{eff}) greater than or equal to 15 (optionally where Z_{eff} excludes any solvates having a boiling point less than or equal to 150° C. at 100 kPa pressure);
wherein the effective atomic number (Z_{eff}) is calculated as:
Z_{eff}=ΣαᵢZᵢ
where Zᵢ is the atomic number of the ith element in the compound, and αᵢ is the fraction of the sum total of the atomic numbers of all atoms in the compound constituted by said ith element.

2. A method of preparing a specimen for imaging, the method comprising:
providing a specimen; and
transforming the specimen into an imagable specimen sample;
wherein transforming the specimen into an imagable specimen sample comprises incorporating a resin composition into the specimen, wherein the resin composition comprises a resin component, and further comprises a self-healing component; wherein the self-healing component is or comprises a compound capable of chemically reacting to bond together at least two fragments of a fragmented molecule (formed following bond scission) so that the compound of the self-healing component bridges together the at least two fragments.

3. The method as claimed in claim 1, wherein transforming the specimen into an imagable specimen sample additionally comprises incorporating a self-healing component (or composition thereof) into the specimen; wherein the self-healing component is or comprises a compound capable of chemically reacting to bond together at least two fragments of a fragmented molecule (formed following bond scission) so that the compound of the self-healing component bridges together the at least two fragments.

4. The method of claim 1, wherein the resin composition is transformable from a fluid or liquid state into a hardened state.

5. The method of claim 1, wherein Z_{eff} is greater than or equal to 30.

6. The method of claim 1, wherein preparing the specimen for imaging involves:
i) optionally preserving the specimen by a chemical fixation treatment;
ii) optionally staining the specimen by contacting the specimen with one or more staining agents, wherein at least one staining agent is an oxidising compound with a standard electrode potential greater than or equal to +0.7V;
iii) infusing the specimen with the resin composition, wherein the resin composition is a fluid resin composition; and
iv) hardening the resin composition to produce a specimen-encapsulated resin block.

7. The method of claim 1, wherein the specimen is a histological specimen sample.

8. An imagable specimen sample obtained by the method of preparing a specimen for imaging of claim 1.

9. A method of imaging an imagable specimen sample, the method comprising:
preparing a specimen for imaging by performing the method of claim 1 to produce an imagable specimen sample; and
imaging the imagable specimen sample.

10. The method of claim 9, wherein imaging is performed via scanning electron microscopy (SEM) to produce SEM image(s).

11. An image obtained by the method of imaging as claimed in claim 9.

12. A method of diagnosing and/or prognosing a medical disease or condition, the method comprising:
i) preparing a specimen for imaging by performing the method of claim 1 to produce an imagable specimen sample
AND
ii) examining the image; and
iii) determining a diagnosis and/or prognosis on the basis of the examination of the image.

13. An imaging preparation composition, the composition comprising a secondary electron generator and/or a self-healing component; wherein:
the secondary electron generator comprises a compound having an effective atomic number (Z_{eff}) greater than or equal to 15 (optionally where Z_{eff} excludes any solvates having a boiling point less than or equal to 150° C. at 100 kPa pressure);
wherein the effective atomic number (Z_{eff}) is calculated as:
Z_{eff}=ΣαᵢZᵢ
where Zᵢ is the atomic number of the ith element in the compound, and αᵢ is the fraction of the sum total of the atomic numbers of all atoms in the compound constituted by said ith element; and
the self-healing component is or comprises a compound capable of chemically reacting to bond together at least two fragments of a fragmented molecule formed following bond scission so that the compound of the self-healing component bridges together the at least two fragments;
wherein the imaging preparation composition is a resin composition, and further comprises a resin component.

14. The imaging preparation composition of claim 13, wherein the resin composition is transformable from a fluid or liquid state into a hardened state.

15. A kit of parts comprising a resin component; and further comprising a secondary electron generator and/or a self-healing component.

16. The method of claim 1, comprising a secondary electron generator that comprises a compound having an effective atomic number (Z_{eff}) greater than or equal to 40 and a density greater than or equal to 2.5 g/cm³.

17. The method of claim 16, wherein the secondary electron generator is free of any species having a highest standard electrode potential greater than or equal to +0.90V.

18. The method of claim 16, comprising a resin component, wherein the secondary electron generator is inert to the resin component.

19. The method of claim 18, wherein the secondary electron generator compound(s) has a Z_{eff} that is at least 30 units higher than the resin component and a density that is at least 2 times higher than the density of the resin component.

20. The method of claim 1, comprising a resin component and a self-healing component, wherein the self-healing component is capable of reacting with a radiation-damaged form of the resin component to join together molecular or polymeric fragments.

21. The method of claim 20, wherein the self-healing component is reactive with free-radicals.

22. The method of claim 21, wherein the self-healing component comprises one or more alkenyl and/or alkynyl moieties.

23. The method of claim 20, wherein the self-healing component is or comprises:
pentaerythritoltetraacrylate (PET), dipentaerythriolpentaacrylate (DPEPA), Pentaerythritol ethoxylate, Pentaerythritol propoxylate, ethylene glycol di(meth)acrylate or a derivative thereof (e.g. ethylene glycol diacrylate, Di(ethylene glycol) diacrylate, Tetra(ethylene glycol) diacrylate, Ethylene glycol dimethacrylate, Di(ethylene glycol) dimethacrylate, Tri(ethylene glycol) dimethacrylate), methylenebisacrylamide or a derivative thereof (e.g. N,N′-Methylenebisacrylamide, N,N′-(1,2-Dihydroxyethylene)bisacrylamide), divinylbenzene or a derivative thereof, 1,4-Bis(4-vinylphenoxy)butane.

24. The method of claim 20, wherein the self-healing component has a Z_{eff} less than or equal to 10 and a density less than or equal to 1.5 g/cm³.

25. The method of claim 20, comprising a resin component, wherein the resin component is a fluid capable of undergoing a transition from a fluid state to a (substantially) solid state.

26. The method of claim 25, wherein the resin component has a Z_{eff} less than or equal to 10 and a density less than or equal to 1.5 g/cm³.

27. The method of claim 25, wherein the resin component is a synthetic resin component comprising a first resin-forming ingredient, a hardener, and optionally an accelerator.

28. The method of claim 27, wherein the first resin-forming component comprises an epoxy resin component, a polyurethane resin component, an acrylic resin component, an acetal resin component, or an unsaturated polyester resin component.
